(19) United States
(12) Patent Application Publication
(10) Pub. No.: US 2015/0024209 A1
(43) Pub. Date: Jan. 22, 2015

(54) MODIFIED PARTICLE PURIFICATION METHOD AND MANUFACTURING METHOD, MODIFIED PARTICLES, FUNCTIONAL MATERIAL, OPTICAL MEMBER, HEAT TRANSFER MEMBER, AND COVERAGE RATE ANALYSIS DEVICE AND COVERAGE RATE ANALYSIS METHOD

(71) Applicant: Sharp Kabushiki Kaisha, Osaka (JP)

(72) Inventor: Tadashi Ohtake, Osaka (JP)

(73) Assignee: Sharp Kabushiki Kaisha, Osaka (JP)

(21) Appl. No.: 14/384,329

(22) PCT Filed: Feb. 26, 2013
(86) PCT No.: PCT/JP2013/055000

§ 371 Date: Sep. 10, 2014

(30) Foreign Application Priority Data
Mar. 12, 2012 (JP) 2012-055081
Jun. 26, 2012 (JP) 2012-143503

(51) Int. Cl. B01D 15/40; G01N 5/04; B05D 1/18; C08K 9/06; B01D 11/02; B05D 7/24

(52) U.S. Cl. CPC B01D 15/40; B01D 11/0203; B05D 7/24; B05D 1/185; C08K 9/06; G01N 5/04
USPC 428/403; 210/660; 210/663; 427/213.3; 524/265; 374/45

(57) ABSTRACT

According to the present invention, a solvent having particles with a primary particle diameter of less than 100 nm to which a surface modification agent is bonded and also having compounds not bonded to the respective surfaces of the particles is made to contact a trap material larger than the particles while the solvent is in a supercritical state. The compounds in the solvent not bonded to the respective surfaces of the particles are trapped by the trap material and removed.

### TECHNICAL FIELD

The present invention is directed to modified particles having a very small amount of impurities, functional material having these modified particles, an optical member, a heat transfer member, and a method of purification and a method of manufacturing modified particles that make it possible to obtain such modified particles. More particularly, the present invention is directed to a coverage rate analysis device and a method of coverage rate analysis that analyzes the coverage rate of a modified material on a surface of a particle that has been modified by this modified material.

### BACKGROUND ART

Recent research in various fields been focused on particles having a particle diameter at the nanometer scale, i.e., nanoparticles (see Patent Documents 1-7 and Non-Patent Documents 1-3, for example).

As part of this, various methods of modifying the surfaces of nanoparticles by a modification agent being bonded thereto are being studied in order to confer different functions to the nanoparticles (see Patent Documents 1-7, Non-Patent Documents 1-3, for example).

In particular, nanoparticles aggregate together with ease due to their minute size, which in many cases makes it impossible for the inherent functions of nanoparticles to be expressed. Nanoparticle surface modification is one technique used for suppressing such aggregation and for stably isolating nanoparticles.

### RELATED ART DOCUMENTS

### Patent Documents

Patent Document 1: Japanese Patent Application Laid-Open Publication, “Japanese Patent Application Laid-Open Publication No. 2010-46625 (Published on Mar. 4, 2010)”
Patent Document 2: Japanese Patent Application Laid-Open Publication, “Japanese Patent Application Laid-Open Publication No. 2010-58984 (Published on Mar. 18, 2010)”
Patent Document 3: Japanese Patent Application Laid-Open Publication, “Japanese Patent Application Laid-Open Publication No. 2005-194148 (Published on Jul. 21, 2005)”
Patent Document 4: Japanese Patent Application Laid-Open Publication, “Japanese Patent Application Laid-Open Publication No. 2009-107857 (Published on May 21, 2009)”
Patent Document 5: Japanese Patent Application Laid-Open Publication, “Japanese Patent Application Laid-Open Publication No. 2007-99607 (Published on Apr. 19, 2007)”
Patent Document 6: Japanese Patent Application Laid-Open Publication, “Japanese Patent Application Laid-Open Publication No. 2004-224583 (Published on Aug. 12, 2004)”
Patent Document 7: Japanese Patent Application Laid-Open Publication, “Japanese Patent Application Laid-Open Publication No. 2007-7524 (Published on Jan. 18, 2007)”

### Non-Patent Documents

Non-Patent Document 1: C. Domingo, et al. “Grafting of trialkoxysilane on the surface of nanoparticles by conventional wet alcoholic and supercritical carbon dioxide deposition methods.” Journal of Supercritical Fluids, vol. 37 (2006): 72-86
Non-Patent Document 2: Zhi-Wen Wang, et al. “Organic modification of nano-SiO₂ particles in supercritical CO₂.” Journal of Supercritical Fluids, vol. 37 (2006): 125-130
Non-Patent Document 3: Bambang Veriansyah, et al. “Characterization of surface-modified ceria oxide nanoparticles synthesized continuously in supercritical methanol.” Journal of Supercritical Fluids, vol. 50 (2009): 283-291
Non-Patent Document 4: Relative surface area analysis using BET method, “Foundation and Application of Surface Science,” Japan Surface Science Society, Aug. 1, 1991: 375-376.

### SUMMARY OF THE INVENTION

### Problems to be Solved by the Invention

Nanoparticles, however, aggregate together with ease, and once aggregated, will remain almost entirely in this state during the modification reaction for bonding the modification agent to the respective surfaces of the nanoparticles. Thus, the aggregated nanoparticles have gaps therebetween, and impurities will enter these gaps after the modification reaction.

As a result, modified nanoparticles that have undergone surface modification by a modification agent being bonded to the respective surfaces thereof are manufactured having a large amount of impurities, such as the unreacted modification agent, by-products, or solvent.

If modified nanoparticles having this large amount of impurities are combined with polymers or the like to form a composite, then the impurities will elute, and the following adverse effects could occur: (a) the composite becomes a plasticizer; (b) the eluted impurities react with unreacted monomers or additives and generate unwanted substances or bubbles; (c) a drop in durability; (d) a change in properties, and the like.

Patent Documents 1 to 7 and Non-Patent Documents 1 to 3 use a supercritical solvent as the reaction field. The reaction field being in a supercritical state in this manner causes the solvent and modification agent to enter between the nanoparticles while in their mass-aggregated state. Therefore, the reaction field being in a supercritical state makes it possible to suppress aggregation of the nanoparticles during the modification reaction.

However, due to the minute size of the nanoparticles, it is not possible to completely prevent re-aggregation after the reaction ends. Consequently, impurities such as unreacted modification agent or by-products enter between the nanoparticles during re-aggregation.

Patent Documents 1 and 2 disclose that nanoparticles generated from a reactant mixture can be separated by a method known in the field, and it is generally possible to use water, a hydrophilic or hydrophobic organic solvent, etc. to perform phase separation, phase distribution, or the like. In such a case, it is preferable that solvent extraction, chromatography, or the like can be used.

Furthermore, Patent Document 2 discloses recovering particles from the reactor after the reaction by using water and methanol and then putting these particles in a centrifuge machine for 20 minutes at 10,100 rpm. Thereafter, the precipitate is collected and ethanol is added thereto, and then centrifugation is performed twice under the same conditions as before, thereby removing unreacted reagents attached to the precipitate.

However, it is very difficult to filter or perform centrifugation on nanoparticles that have a particle diameter of less than 100 nm. Experience dictates that it is practically impossible to separate the unreacted reagents by merely performing centrifugation twice for 20 minutes at 10,100 rpm each.

In other words, there are spaces between the nanoparticles in the aggregate of nanoparticles, and impurities will enter into these spaces after the modification reaction. Furthermore, even if aggregation during the modification reaction is suppressed, re-aggregation will occur after the modification reaction and impurities will be introduced into the spaces between the nanoparticles during this time.

Thus, separation takes time, and generally used methods of purification for bulk matter such as filtering or centrifugation, while possible to implement with particles at the micron scale, make it difficult to separate impurities that have entered between the aggregated nanoparticles.

As a result, it is necessary to perform centrifugation at high speeds for a long period of time in the above situations, for example.

Furthermore, a similar peak is observed in the IR spectrum regardless of whether the modification agent is bonded to the respective surfaces of the nanoparticles or in the spaces between non-bonded nanoparticles.

As a result, for nanoparticles under 100 nm, even if the peak of the modification agent is found in the IR spectrum, it is not possible to determine whether or not it is the peak of the modification agent that is actually bonded to the surface of the nanoparticles.

Patent Document 3 is directed to recovery of organic modified particles that are products, and discloses recovering the products by two rounds of water and chloroform washing.

“Washing,” although not described in detail, could include filtering or centrifugation.

As described above, however, it is very difficult to filter or perform centrifugation on nanoparticles having a particle diameter that is less than 100 nm.

Patent Document 3 also discloses a visible peak in the IR spectrum thought to be the modification agent for the particles after the modification reaction. Due to the reasons described above, however, Patent Document 3 still has the problem of a large amount of leftover unreacted modification agent.

Patent Document 4 discloses a surface modification agent attached by reaction to the surfaces of hollow silica nanoparticles in the presence of an organic solvent. Thereafter, the dispersible hollow silica nanoparticles having modified surfaces are stirred and dispersed by a high-speed stirrer. Next, ultrasonic dispersion is performed in the presence of modified silicone oil, and then filtering is done by a sieve having a 25 μm net, thereby obtaining a highly concentrated dispersion fluid.

Patent Document 4 also discloses a method in which an organic solvent and surface modification agent are added to the hollow silica nanoparticles and the nanoparticles are stirred in a high-speed stirrer to disperse the aggregated nanoparticles, which have a particle diameter of approximately 5 μm, into the organic solvent. Thereafter, filtering is performed with a sieve and the nanoparticles are forcefully dispersed by wet jet milling to form small aggregated particles with a particle diameter of less than approximately 0.5 μm. Next, evaporation and heating/drying is performed to obtain dispersible hollow silica nanoparticles having modified surfaces.

However, in any case the nanoparticles are in an aggregated state, and nothing in particular is mentioned about removal of the unreacted modification agent or by-products.

There is also no mention of methods of removing unreacted modification agent or by-products after the modification reaction in Patent Documents 5 and 6. Patent Document 5 lists an IR chart of inorganic particles before and after the modification reaction, but as described above, in Patent Document 5 unreacted modification agent or by-products after the modification reaction are not removed, and the problem of a large amount of leftover unreacted modification agent is not solved.

Non-Patent Documents 1 to 3 describe extracting products with a solvent, filtering, and drying. In this case, however, due to the reasons mentioned above, the problem of a large amount of leftover unreacted modification agent is not solved.

Patent Document 7 discloses a method of collecting generated ultra-fine particles as monodisperse particles. A coolant in which a surfactant has been dissolved is injected into a supercritical solution and then the supercritical solution is rapidly cooled from the outside in order to generate ultra-fine particles. The ultra-fine particle surface adsorbs the surfactant and the generated ultra-fine particles are collected as monodisperse particles.

Patent Document 7, however, has no mention of a method of removing the used surfactant.

Patent Documents 1 to 7 and Non-Patent Documents 1 to 3 also have no descriptions or data related to the purity of the products.

As described above, conventionally it was not known whether impurities had entered the aggregated nanoparticles, and even if it was known, there was no method of removing the impurities that had entered the aggregated nanoparticles.

Therefore, even if a purification process is performed, as described above, general methods of separation such as filtering or centrifugation only separate the nanoparticles from the reactant mixture and only remove unreacted modification agent or by-products dispersed in the solvent; therefore, unreacted modification agent or by-products that have entered the aggregated nanoparticles are not removed.

Thus, conventionally there was no proposal for a method of conveniently and precisely removing impurities in a system.

The present invention was made in view of the above-mentioned problems, and a first aim thereof is providing modified particles that have a very small amount of impurities, a functional material having these modified particles and having a higher functionality than conventional materials, an optical member, a heat transfer member, and a method of purification and a method of manufacturing modified particles in which it is possible to obtain these modified particles.

It is known that the characteristics of a sample constituted of particles modified by a modification material is dependent on the surface state of the particles, in most cases. In particular, the coverage rate analysis, which is the proportion of the surface area of a particle modified by the modification material to the total area of the particle, is an important parameter that influences the characteristics of a sample constituted of particles. Hereinafter, the sample constituted of particles is also referred to simply as a “sample.”

Relative surface area analysis methods such as the BET adsorption method (hereinafter, also referred to simply as the “BET method”) are widely used as methods of analyzing the coverage rate. The BET method adsorbs an inert gas (an N₂ gas, for example) onto the surface of cooled particles, and the relative surface area per unit volume is measured from the amount of the inert gas. When using the BET method, the coverage rate of the particle can be calculated as a proportion of the relative surface area of the particle that has not been modified by the modification material to the relative surface area of the particle that has been modified by the modification material. Specific information about the BET method is described in Patent Document 4, for example.

When using the BET method to measure coverage rate of a sample, however, the measuring accuracy sometimes drops. The drop in measuring accuracy of the coverage rate is due to a drop in measuring accuracy of the relative surface area of the particle that has been modified by the modification material.

The reason that the measuring accuracy of the relative surface area using the BET method drops for particles modified by the modification material will be explained with reference to FIG. 12. FIG. 12(a) is a schematic view of the surface of a particle not modified by the modification material. FIG. 12(b) is a schematic view of the surface of a particle modified with a small amount of the modification material. FIG. 12(c) is a schematic view of the surface of a particle modified with a relatively large amount of the modification material.

As shown in FIG. 12(a), when not modified by the modification material, the N₂ molecules are uniformly adsorbed onto the surface of the particle. As shown in FIG. 12(b), when modified with a small amount of the modification material, the N₂ molecules are uniformly adsorbed onto the surface of the particle, except for the areas modified by the modification material. Accordingly, in both of these cases, the relative surface area of the sample can be accurately measured using the BET method.

As shown in FIG. 12(c), when modified with a relatively large amount of the modification material, there are areas to which the N₂ molecules are not adsorbed on the surface of the particle, in addition to the areas modified with the modification material. This is due to it becoming harder for N₂ molecules to enter between the respective modification material, which results in areas to which N₂ molecules are not adsorbed even if these are areas to which the molecules are originally supposed to be adsorbed. In this case, if the relative surface area of the areas modified by the modification material is calculated on the basis of the amount of N₂ adsorption, then the calculation will inevitably include areas that have not actually been modified by the modification material. This results in a decrease in accuracy of the coverage rate, which is obtained on the basis of the relative surface area of the areas modified by the modification material.

A second aim of the present invention is to provide a coverage rate analysis device and a coverage rate analysis method capable of accurately measuring the coverage rate of a sample surface that is modified by the modification material.

### Means for Solving the Problems

In order to achieve the first aim described above, a method of purifying modified particles according to one aspect of the present invention includes trapping and removing, in a solvent having fine particles and compounds, the compounds not bonded to respective surfaces of the fine particles, the trapping and removing being performed by a trap material that is larger than the fine particles by the trap material coming into contact with said solvent when said solvent is in a supercritical state, the fine particles each having a primary particle diameter of less than 100 nm.

In order to achieve the first aim described above, a method of purifying modified particles according to one aspect of the present invention includes: bonding a surface modification agent to respective surfaces of fine particles in a supercritical solvent by said fine particles and said modification agent being in contact with each other, said fine particles each having a primary particle diameter of less than 100 nm; and removing compounds not bonded to the respective surfaces of the fine particles in said solvent by trapping the compounds using a trap material, said removing being performed by the trap material being in contact with the supercritical solvent having said compounds and said fine particles, the trap material being larger than the fine particles.

In order to achieve the first aim described above, a modified particle according to one aspect of the present invention has a primary particle diameter of less than 100 nm and a surface to which a surface modification agent is bonded, wherein an impurity ratio of the modified particle as measured by a pyrolysis-gas chromatography-mass spectrometry analysis method is less than 30%.

In order to achieve the second aim described above, a coverage rate analysis device according to one aspect of the present invention includes: a thermogravimetric analysis unit that performs thermogravimetric analysis on the sample in a state in which the sample is modified by the modification material, and that measures a mass of said modification material modifying the surface of the sample; a relative surface area analysis unit that performs relative surface area analysis on the sample in a state in which the sample is not modified by the modification material, and that measures the relative surface area of the surface of the sample; and a control unit that calculates the coverage rate on the basis of the mass of the modification material measured by the thermogravimetric analysis unit and the relative surface area of the sample measured by the relative surface area analysis unit.

In order to achieve the second aim described above, a method of analyzing coverage rate according to one aspect of the present invention is a method of analyzing coverage rate expressing a proportion of area modified by a modification material on a surface of a sample modified by this modification material, the method including: performing thermogravimetric analysis on the sample in a state in which the sample is modified by the modification material, and measuring a mass of said modification material modifying the surface of the sample; performing relative surface area analysis on the sample in a state in which the sample is not modified by the modification material, and measuring the relative surface area of the surface of the sample; and calculating the coverage rate on the basis of the mass of the modification material measured by performing the thermogravimetric analysis and the relative surface area of the sample measured by performing the relative surface area analysis.

Additional objects, features, and effects of the present invention shall be readily understood from the descriptions that follow. Advantages of the present invention shall become apparent by the following descriptions with reference to the appended drawings.

### Effects of the Invention

According to the present invention, a solvent having particles with a primary particle diameter of less than 100 nm to which a surface modification agent is bonded and also having compounds not bonded to the respective surfaces of the particles is made to contact a trap material larger than the particles while the solvent is in a supercritical state. The compounds in the solvent not bonded to the respective surfaces of the particles are trapped by the trap material and removed.

Therefore, unreacted modification agent or compounds such as the by-products, i.e., impurities, that are not bonded to the respective surfaces of the particles can be trapped and removed in a state in which the particles, the respective surfaces to which the surface modification agent is bonded, are dispersed as primary particles or a similar state.

Accordingly, with the method described above, it is possible to provide modified particles that are monodisperse and have a very small amount of impurities, and a method of purification and a method of manufacturing modified particles, which makes it possible to obtain these modified particles.

A functional material having these modified particles, an optical member and a heat transfer member made of this functional material, and the like will not be adversely affected by elution of the impurities, and can have and disperse even more modified particles. Therefore, according to the present invention, it is possible to provide goods such as a functional material, optical member, and heat transfer member having a high functionality that exceeds conventional materials.

Furthermore, the mass of the modification material that is modifying the sample surface is measured by thermogravimetric analysis, and the relative surface area of the surface of the sample not modified by the modification member is measured by relative surface area analysis. The coverage rate of the sample modified by the modification agent is calculated on the basis of the mass of the measured modification agent and the relative surface area of the unmodified sample, thereby allowing the coverage rate to be accurately calculated.

### BRIEF DESCRIPTION OF THE DRAWINGS

FIG. 1 is a schematic view of nanoparticles when a supercritical fluid is used during a modification reaction process and a purification process.

FIG. 2 is a schematic view of nanoparticles when a supercritical fluid is not used in the modification reaction process and the purification process.

FIG. 3 is a schematic view of nanoparticles when a supercritical fluid is used only during a modification reaction process.

FIG. 4 is a graph showing the relationship between particle diameter of the modified nanoparticles and unmodified nanoparticles and the composite quantity in PMMA when the surface-modified nanoparticles and the unmodified nanoparticles each form composites.

FIG. 5 is a decomposition GC chart of products obtained in Embodiment 1.

FIG. 6 is a decomposition GC chart of products obtained in Comparison Example 1.

FIG. 7 is a schematic view of a coverage rate analysis device according to one embodiment of the present invention.

FIG. 8 is a view of the process flow of the coverage rate analysis device according to one embodiment of the present invention.

FIG. 9 is a view of the process flow of the coverage rate analysis device according to one embodiment of the present invention.

FIG. 10(a) is a view of the coverage rate measured in one embodiment of the present invention, and FIG. 10(b) is a plot of the coverage rate to the modification reaction time when the modification agent is used.

FIG. 11(a) is a view of the coverage rate obtained using only relative surface area analysis, and FIG. 11(b) is a plot of the coverage rate to the modification reaction time when the modification agent is used.

FIGS. 12(a) to 12(c) are schematic views of an inert gas being adsorbed onto a sample surface while measuring the coverage rate by relative surface area analysis in a conventional method of coverage rate analysis.

### DETAILED DESCRIPTION OF EMBODIMENTS

### Embodiment 1

Below, Embodiment 1 of the present invention will be explained in detail.

The present embodiment is directed to a method of manufacturing modified particles (hereinafter, “modified nanoparticles”), which are particles having a particle diameter at the nano scale (i.e., nanoparticles) that have had the surfaces thereof modified. More particularly, the present invention is at least directed to a method of using a supercritical solvent (supercritical fluid) in the initial stages of a purification process.

<Comparison of Methods of Manufacturing Modified Nanoparticles>

A method of manufacturing modified nanoparticles according to the present embodiment includes at least a modification reaction process and a purification process.

Assuming that the method of manufacturing modified nanoparticles is divided into a modification reaction process and a purification process, methods of manufacturing modified nanoparticles mainly include four possibilities: (1) not using a supercritical fluid in either the modification reaction process or the purification process; (2) using a supercritical fluid in only the modification reaction process; (3) using a supercritical fluid in both the modification reaction process and the purification process; and (4) using a supercritical fluid in only the purification process.

In the present embodiment below, using a supercritical fluid in both the modification reaction process and the purification process is used as an example and compared to a conventional purification process.

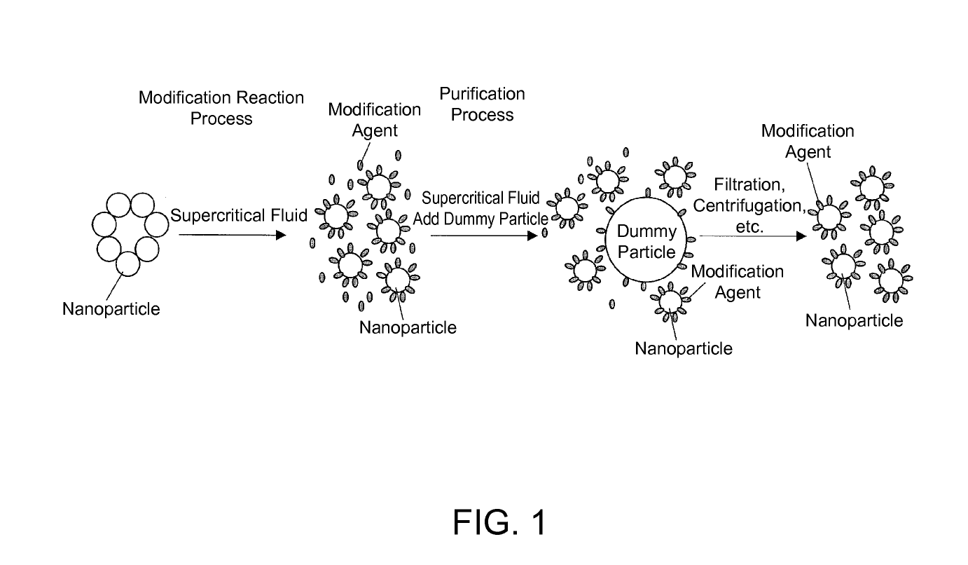

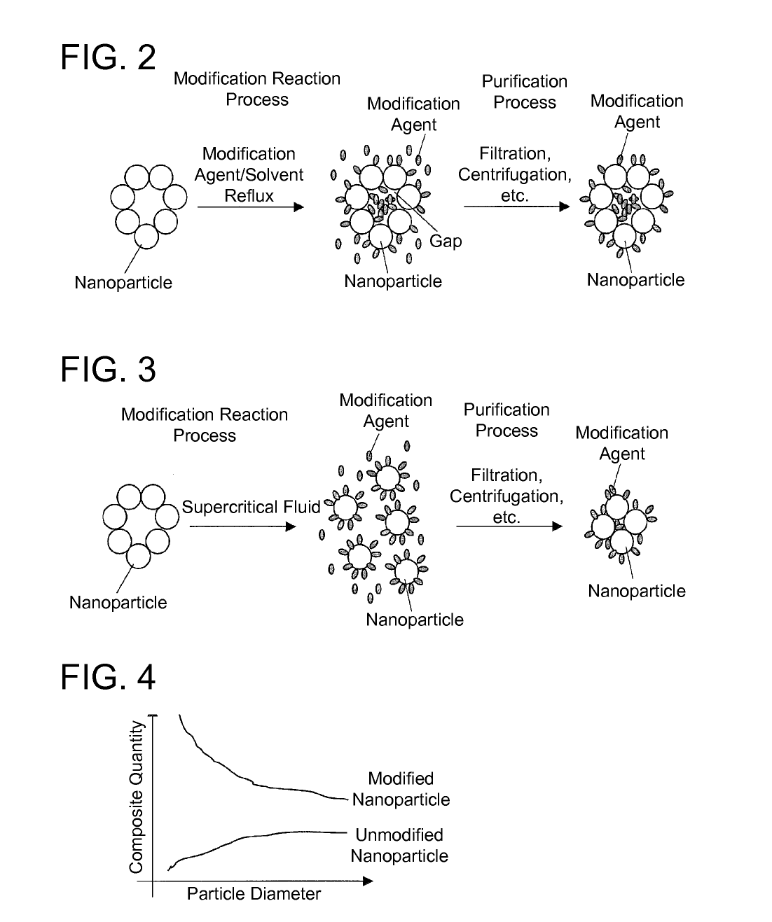

FIG. 1 is a schematic view of nanoparticles when (3) a supercritical fluid is used during the modification reaction process and the purification process. FIGS. 2 and 3 are schematic views of nanoparticles when (1) not using a supercritical fluid in either the modification reaction process or the purification process and (2) using a supercritical fluid in only the modification reaction process.

<(1) Not Using Supercritical Fluid in Either Process>

As shown in FIG. 2, when the supercritical fluid is not used in either process, in the modification reaction process, a surface modification agent (hereinafter, simply referred to as a “modification agent”) and solvent is added to the nanoparticles and reflux is performed to bond the modification agent to the surface of the nanoparticles. Ultrasonic exposure and ball milling are sometimes used, but it is known that these methods do not sufficiently disperse materials down to the primary particle level.

Ordinarily, however, nanoparticles aggregate, and if the reaction is performed in a normal solvent, then this aggregation of nanoparticles will remain without completely breaking apart. Therefore, in this case, impurities such as unreacted modification agent, by-products, and solvent will enter into the spaces in the aggregate body of the nanoparticles having modified surfaces.

Thus, it is impossible to assume that performing a regular purification process such as filtering or centrifugation in this state will result in modified nanoparticles with a high purity.

<(2) Using Supercritical Fluid in Only the Modification Reaction Process>

As shown in FIG. 3, when performing the modification reaction process using the supercritical fluid (supercritical solvent), the reaction field is in a supercritical state, thereby allowing the nanoparticle aggregation during the modification reaction process to be broken apart.

In other words, when performing the modification process in a supercritical state, even if the nanoparticles aggregate into secondary particles, tertiary particles, or the like, the supercritical fluid and the modification agent will permeate between the nanoparticles forming the secondary particles, tertiary particles, or the like. As a result, the respective nanoparticles, which are primary particles, will react with the modification agent, and modified nanoparticles will be formed by the modification agent bonding to the surfaces of the respective nanoparticles. Thus, the modified nanoparticles mutually disperse as primary particles (or a similar state), and impurities such as unreacted modification agent or by-products are present around these modified nanoparticles.

If a supercritical state is not used during purification, however, then re-aggregation is unavoidable, and the impurities surrounding the modified nanoparticles will enter when the modified nanoparticles re-aggregate into secondary particles, tertiary particles, or the like.

Therefore, despite the amount of impurities being markedly reduced as compared to (1), it is difficult to remove the impurities that have entered between the aggregated nanoparticles by filtering or centrifugation, resulting in the manufacture of modified nanoparticles having a large amount of impurities between the aggregated nanoparticles.

If modified nanoparticles having this large amount of impurities are combined with polymers or the like to form a composite, then as described above, the impurities will elute, and the following adverse effects could occur: (a) the composite becomes a plasticizer; (b) the eluted impurities react with unreacted monomers or additives and generate unwanted substances or bubbles; (c) a drop in durability; (d) a change in properties, and the like.

<(3) and (4) Using Supercritical Fluid in the Purification Process>

Thus, in the present embodiment, as shown in FIG. 1, in the beginning of the purification process a dummy particle is added as a trap material to trap the impurities while the solvent is in a supercritical state.

If the dummy particle is added while the field is in a supercritical state, then the impurities can be trapped by the dummy particle in a state in which the modified nanoparticles are dispersed as primary particles or a similar state.

Accordingly, if the dummy particle is removed after the impurities have been trapped by the dummy particle, then it is possible to obtain modified nanoparticles that are monodisperse and have very few impurities.

Therefore, if the nanoparticles are combined with polymers or the like to form a composite, then adverse effects such as those described above in (a) to (d) when nanoparticles having a large amount of impurities are combined with polymers or the like to form a composite will not occur.

<(4) Using Supercritical Fluid Only in the Purification Process>

FIG. 1 shows an example of using a supercritical fluid in both the modification reaction process and the purification process as shown in (3), but the present embodiment is not limited to this, and the supercritical fluid may be used only in the purification process as shown in (4), for example.

Since the supercritical fluid was not used in the reaction process, as shown in the center of FIG. 2, the modified nanoparticles aggregate into secondary particles, tertiary particles, or the like after the modification reaction. Despite this, if a dummy particle is added while the solvent is in a supercritical state in badge processing, then the supercritical solvent permeates into the aggregated nanoparticles and breaks the aggregate apart, for example. Therefore, impurities can be trapped by the dummy particle in a state in which the nanoparticles are primary particles or a similar dispersed state.

Accordingly, by using the supercritical fluid in at least the initial stage of the purification process, modified nanoparticles having few impurities can ultimately be obtained.

Nanoparticles, however, aggregate together with ease, and as shown in FIG. 2, if a reaction is performed in a normal solvent, the aggregate will remain almost completely intact until the products are obtained. Therefore, it is not possible to efficiently bond the modification agent to the respective surfaces of the nanoparticles. Furthermore, a lot of modification agent not bonded to the respective surfaces of the nanoparticles remains in the solvent, which wastes more modification agent than if the supercritical fluid were used in the modification reaction process.

<(3) Using Supercritical Fluid in Both the Modification Reaction Process and the Purification Process>

Therefore, as shown in FIG. 1, it is more preferable that the modification reaction process and the purification process be performed as a series of modified nanoparticle manufacturing processes using batch processing, and that the supercritical fluid be used in both the modification reaction process and the purification process.

As described above, when using the supercritical fluid in the modification reaction process, even if the nanoparticles aggregate into secondary particles, tertiary particles, or the like, then the supercritical fluid and modification agent will permeate into the aggregated nanoclusters and bond to the surfaces of the respective nanoparticles. Thus, the obtained modified nanoparticles mutually disperse as primary particles (or a similar state), and impurities such as unreacted modification agent or by-products are present around these modified nanoparticles. If the dummy particle, which is the trap material, is present in this state along with the impurities such as the unreacted modification agent, then such impurities can be efficiently removed from the system.

In this case, modified nanoparticles having a high coverage rate of the modification agent on the nanoparticle surfaces and a very small amount of impurities can be obtained.

If the coverage rate of the modification agent on the nanoparticle surfaces is high, then dispersibility will be improved, resulting in it being harder for the nanoparticles to aggregate and further helping to prevent impurities from entering.

High dispersibility improves the filling rate when modified nanoparticles are combined with polymers or the like to form composites.

In general, the smaller the diameter of a particle, the larger the effects of surface energy are on the characteristics thereof. If particles are dispersed in a polymer, for example, then the smaller the particle diameter of the particle, the larger the surface energy of the particle will be, and the larger the interaction between the particle and the polymer, for example. Therefore, if the particle diameter of the particle is small, the dispersibility of the particle in the polymer tends to be low. To reduce the amount of this interaction between the particle and the polymer, it is effective to reduce the interface area, or namely, to increase the particle diameter.

However, this is only true if the particle surface is hydrophilic. If the particle has been modified and the hydrophilicity thereof has been reduced, then the complete opposite applies.

In other words, an increase in the affinity of particles to polymers means that the interface size has increased, or namely, that the particle diameter has become smaller. Accordingly, to disperse an even greater number of particles in the polymer, it is preferable to reduce the hydrophilicity of the particles and to decrease the particle diameter.

FIG. 4 is a graph showing the relationship between particle diameter of the modified nanoparticles and unmodified nanoparticles and the composite quantity in PMMA (polymethylmethacrylate) when the surface modified nanoparticles and the unmodified nanoparticles each form composites with the PMMA.

As shown in FIG. 4, the composite quantity of the modified nanoparticles in the PMMA increases as the particle diameter of the modified nanoparticles increases.

Therefore, favorable monodisperse modified nanoparticles can form favorable composite materials.

In other words, by using such modified nanoparticles with polymers or the like to form a composite, then not only are there no adverse affects such as those described in (a) to (d) above, but the composite quantity of the modified nanoparticles can also be increased. The characteristics (such as permittivity, refractive index, thermal conductivity, and durability, for example) of the composite material itself can also be significantly improved.

Ordinarily, when using nanoparticles with polymers or the like to form composites, a dispersant is used in order to ensure dispersibility. The dispersant is used to improve the mixability of the nanoparticles and the medium of the polymer or the like, but it is normal to use a quantity that is at least half the quantity of nanoparticles, and more preferably a quantity that is equal to the quantity of nanoparticles.

However, to achieve a composite material with a high refractive index, for example, titanium oxide (TiO₂) is generally added at approximately 10 wt % of the total amount of polymers when being added as nanoparticles to a polymer.

As described above, however, in order to ensure dispersibility of the nanoparticles, a dispersant (normally, an organic surfactant) is required in a quantity equal to half of the nanoparticles or a quantity approximately equal thereto. In this case, even if TiO₂ is added to achieve a highly refractive index of approximately 2.5 or above in order to form a highly refractive index composite material, the surfactant, which has a comparatively low refractive index of approximately 1.45, must be added in considerable quantities. Therefore, conventionally it has not been possible to effectively improve the refractive index.

Furthermore, the organic surfactant, which has no actual relationship with increasing the refractive index in the first place, can turn into a plasticizer, lower the glass-transition point and thermal resistance, and reach a point where it is merely a type of impurity.

However, if modified nanoparticles having a very small amount of impurities and high dispersibility are used, then it is not necessary to add a dispersant in such large quantities, and thus the benefits of using these modified nanoparticles are very great.

Similar things could be said for other general characteristics, such as permittivity, thermal conductivity, thermal resistance, and resistance to ultraviolet rays, for example.

The respective processes are described in more detail below.

<Modification Reaction Process>

The modification reaction process is a process for bonding the modification agent to the nanoparticle surfaces by making the nanoparticles and modification agent contact each other in a solution. As shown by the modification reaction portion in FIGS. 1 and 2, it is possible to use various types of well-known modification reaction processes that cause the modification agent to bond to the nanoparticle surfaces.

As shown by the modification reaction process in FIG. 1, for example, when the nanoparticles and the modification agent contact each other in the supercritical fluid to cause the modification agent to bind to the nanoparticle surfaces, this modification reaction process in question could be those shown in Patent Documents 1-6 or Non-Patent Documents 1-3, for example.

<Purification Process>

The purification process is a process for trapping and removing the compounds not bonded to the nanoparticle surfaces in the supercritical fluid.

“Compounds not bonded to the nanoparticle surfaces” means impurities besides the modified nanoparticles, and mainly refers to the modification agent and by-products not bonded to the nanoparticle surfaces.

The process of trapping the compounds not bonded to the nanoparticle surfaces with a trap material and the process of removing the compounds not bonded to the nanoparticle surfaces from the system may be performed separately or may be performed simultaneously.

In other words, the purification process may include two processes: mixing in a trap material while a solvent is in a critical state, the solvent having modified nanoparticles and free compounds not bonded to the modified nanoparticles, and trapping the compounds not bonded to the nanoparticle surfaces with the trapping material; and removing the trap material from the system, or more specifically, from the solvent.

Alternatively, the purification process may include a process in which the supercritical solvent having the modified nanoparticles and the free compounds not bonded to the nanoparticles pass through a vessel housing the trap material in order to trap the compounds not bonded to the nanoparticle surfaces in the solvent to remove these compounds.

The purification process may include a process of drying the modified nanoparticles after the compounds are removed.

Next, the constituting elements used in the respective processes will be explained. First, the materials used in the respective processes will be explained.

<Nanoparticles>

In the present embodiment, it is preferable that particles having a primary particle diameter of less than 100 nm be used as the nanoparticles that are the starting material.

Particles that have a primary particle diameter of less than 100 nm are difficult to filter and to perform centrifugation on, and thus, the purification process according to the present embodiment is an essential element in obtaining modified nanoparticles having a very small amount of impurities.

The particle diameter of the nanoparticles can be measured using a well-known measuring method, such as transmission electron microscopy, adsorption, light scattering, X-ray small angle scattering, X-ray diffraction, or the like. Needless to say, commercially available nanoparticles having the above-mentioned primary particle diameter may be used.

The nanoparticles are used as core (nuclear particles) of the modified nanoparticles. There are no specific limitations to the nanoparticles, as long as the particles do not dissolve in a supercritical solution used as a reaction field in a reaction system.

Examples of these nanoparticles include inorganic particles, but the nanoparticles may be organic particles constituted of an organic material such as a cross-linkable compound, or may be composite particles that have either an organic material or an inorganic material as the main component.

Examples of the nanoparticles include zinc oxide, aluminum oxide, silicon nitride, aluminum nitride, titanium oxide, titanate, zirconate titanate, niobate, tantalate, tungstate, gallium phosphate, Rochelle salt, topaz, tourmaline, silica, or the like.

These nanoparticles may be used on their own or two or more types may be appropriately combined.

<Modification Agent (Surface Modification Agent>

There are no particular limitations to the modification agent, as long as the agent can bond to the surfaces of the respective nanoparticles. The modification agent may be appropriately selected depending on the desired functions or the like to be given to the varieties of nanoparticles or single variety of nanoparticles. Various types of well-known modification agents that are capable of chemically bonding organic residues to the surface of the respective nanoparticles can be used as the modification agent, for example.

Isocyanate-based compounds, amine compounds, vinyl-based compounds, epoxy-based compounds, methacryloxy-based compounds, acrylic compounds, imide compounds, and the like, and the well-known organic modification agents described in Patent Documents 1-6 and Non-Patent Documents 1-3 can be used as the modification agent, for example.

In addition to the modification agents described in Patent Documents 1-6 and Non-Patent Documents 1-3, silane compounds (organic functionalized silane) such as octadecyltrimethoxysilane, dimethoxydiphenylsilane, or a silane coupling agent such as amino trimethoxysilane can be used alone or in combination with the organic modification agents described above. Such compounds firmly chemically bond to the respective surfaces of the inorganic or organic nanoparticles through a condensation reaction or the like. This makes it possible to obtain modified nanoparticles in which the organic functional group is firmly bonded to the respective surfaces of the nanoparticles through a reactive silyl group, a silanol group, or the like, the nanoparticles being constituted of silica particles, titanium oxide, aluminum oxide, or the like, and having a modification agent that is not susceptible to being torn off, for example.

<Solvent>

As described above, it is preferable that a supercritical fluid (a solvent in a supercritical state) be used as the solvent in the method of manufacturing the modified nanoparticles of the present embodiment, or namely, as the reaction field of the modification reaction and the processing field of the purification process in the present embodiment.

“Supercritical fluid” means a substance at a temperature and pressure above its critical point, and signifies that the substance is in a state where distinct liquid and gas phases do not exist.

The solvent used in the present embodiment has no particular limitations, and aliphatic alcohol such as methanol, ethanol, and propanol, aliphatic hydrocarbons such as n-hexane and ketone, aromatic hydrocarbons such as xylene, carbon dioxide, water, or the like, and the solvents described in Patent Documents 1-7 and Non-Patent Documents 1-3 can be used as the solvent in the present embodiment, for example.

Among these, it is preferable that carbon dioxide, methanol, ethanol, acetone, or water be the solvent used as the supercritical fluid in the present embodiment due to ease of use in regards to temperature and pressure. It is further preferable that carbon dioxide or methanol be used due to high solubility with respect to various substances and the ability to be handled at a relatively low temperature and low pressure. Methanol is appropriate if the polarity of the modification agent is high.

It is also preferable to add a small amount of other organic solvents to these supercritical fluids. It is known that by adding these other organic solvents to the supercritical fluids (namely, organic solvents not in a supercritical state due to different critical points), the solubility of the solute will be improved (the entrainer effect). This is thought to accelerate the modification reaction.

<Trap Material>

The trap material has no particular limitations, as long as the trap material is larger than the nanoparticles and can trap (capture) impurities, the unreacted modification agent in particular, which are not bonded to the nanoparticle surfaces in the supercritical fluid.

“Capture” in this context may mean securing by adsorption, or may mean securing by chemically bonding.

If the trap material is larger than the nanoparticles, then the trap material may be made with the same material as the nanoparticles, or may be made with a different material. A trap dummy particle having a larger diameter than the nanoparticles and made of the same material as the nanoparticles may be used as the trap material in the present embodiment, for example.

The size of the trap material should be larger than the nanoparticles, as described above, but it is preferable that the size be at least at the micron level.

There are no particular limitations to the material of the trap material, as long as the material can trap the impurities not bonded to the nanoparticle surfaces, the unreacted modification agent in particular, in the supercritical fluid.

An example of the trap material includes an adsorbent having a hydrophilic surface. An example of such an adsorbent includes polar adsorbents such as silica or alumina.

Silica and alumina are preferable as the trap material due to having large relative surface areas, excellent adsorption capabilities, and being resistance to heat and resistant to water. Additionally, silica and alumina can adsorb many of the organic compounds having modifiable functional groups that could potentially be used as the modification agent.

The trap material used in the present embodiment, however, is not limited to this, and a material having a hydrophobic surface may be used, or a material having both hydrophilic groups and hydrophobic groups on the surface thereof may be used. The trap material may be a single type, or two or more types may be appropriately combined for the trap material. In other words, the trap material may be suitably selected or combined depending on the type of solvent, modification agent, and the like.

To adsorb organic material with a weak polarity from a polar solvent, it is preferable that an adsorbent such as activated carbon with a hydrophobic surface be used, for example. If the processing field is water-based, particles with high hydrophobicity generally tend to aggregate with ease, but this can be suppressed by using a supercritical fluid.

By using a polar adsorbent such as silica or alumina with a hydrophilic surface as the trap material, water and other polar molecules can be selectively adsorbed, while an adsorbent with a hydrophobic surface can selectively adsorb nonpolar molecules.

When using a trap dummy particle having a larger diameter than the nanoparticles and made of the same material as the nanoparticles, unreacted modification agent can be made to bond to the surface of the trap dummy particle by the trap dummy particle and the unreacted modification agent being in contact with each other in the supercritical fluid, for example.

When the trap material has an affinity with unreacted modification agent, as is the case for a dummy particle made of the same material as the nanoparticles, then the unreacted modification agent can be efficiently trapped and collected.

When the nanoparticles are particles having a hydrophilic surface such as silica, the particle itself is hydrophilic, but this hydrophilicity is reduced by modification, for example. As a result, surface modification of the nanoparticles suppresses adsorption of impurities onto the modified nanoparticles. In the purification process, mixing the unmodified trap material with the modified nanoparticles in this state makes it possible to efficiently adsorb impurities.

The shape of the trap material has no particular limitations, and may have a particle shape, a fiber shape such as glass wool, or preferably a fiber bundle or cotton fiber shape.

Forming the trap material in a fiber shape in this manner and increasing the surface area makes it possible to trap the impurities in the fiber-like mesh with ease.

It is preferable that the trap material be removed from the purification system with ease and have sufficient surface area. Therefore, it is preferable that an adsorbent with a multi-porous structure be used as the trap material, due to the relatively large surface area. Such a trap material has no particular limitations, as long as the hole diameter in the trap material surface is smaller than the nanoparticles.

The trap material can be separated and removed with ease by filtering with a filter, sieve, or the like that has a diameter larger than the nanoparticles but smaller than the trap material. Accordingly, the size of the trap material has no particular limitations, as long as the trap material is larger than the nanoparticles, but it is preferable that the trap material be a size that can be removed with ease by filtering or centrifugation, for example, such as a diameter of approximately several μm to several hundred μm, for example.

The trap material is directly mixed into the solvent, and may be removed from the solvent after trap processing, or may be housed in a vessel such as a column as a purification system that is separate from the reaction system.

In this case, an openable and closable connection member is provided that has connection parts (connection ports) such as valves between a reaction vessel used for the modification reaction and a housing vessel that houses the trap material. By connecting to the housing vessel having the trap material and then opening the connection ports after the modification reaction is finished, the supercritical solvent having the modified nanoparticles and the impurities not bonded to the surfaces of the modified nanoparticles after the modification reaction can be passed through the housing vessel while still in a supercritical state, without returning back to normal temperature or normal pressure (in other words, room temperature and atmospheric pressure).

This makes it possible to trap and remove the compounds not bonded to the nanoparticle surfaces in the solvent with the trapping material, without removing the trapping material from a separate solvent.

When using glass wool as the trap material, then the glass wool need only be removed by being raised out of the solvent and the like, for example.

When using glass wool as the trap material or the trap material stored in the housing vessel such as a column, or when the processing liquid has impurities larger than the nanoparticles, or when there is a large amount of residual solvent, then the purification process may further include a process in which the processed liquid is filtered after the glass wool is removed or after being passed through the vessel in which the trap material is housed, such as a silica column.

<Manufacturing Device>

The reaction field in the modification reaction process and the processing field in the purification process can be obtained in a device that is capable of achieving high temperature and high atmospheric conditions.

Such a device, or namely, a device for turning a field (specifically, the solvent used in the respective processes) into a supercritical state, has no particular limitations, and a batch device can be used, for example, and generally an autoclave (pressure-resistance reactor) or the like can be used.

The reactor device used in the modification reaction process and the processing device used in the trapping of impurities in the purification process may be different from each other, but it is preferable that the devices be the same when the purification process is performed after the modification reaction as a series of processes related to manufacturing modified nanoparticles. This is done to prevent a drop in yield.

In other words, when transitioning from the reaction process to the purification process, it is fine to temporarily return to a low temperature and low pressure (ordinary temperature and pressure, for example) and then transition to the purification process thereafter, depending on the case, but it is preferable that the purification process be transitioned to while the supercritical fluid still has the reacted material and the trap material, without canceling the high temperature and high pressure state.

The housing vessel such as a silica or alumina column in which the trap material is housed (filled, for example), may be connected to the reactor device as an impurity removing device through a connection member such as a valve, for example.

This makes it possible to continue to remove impurities after the modification reaction without removing the reaction liquid from the reactor device.

A filtering device such as a decompression filtering device can be connected to the processing device as an impurity removing device through connection members such as valves, for example.

This makes it possible to continue to remove the trap material and impurities after the trap material has trapped the impurities, without removing the processing liquid from the processing device.

An input port for inputting the trap material into the device after the modification reaction may be separately disposed on the device, or an adding device for adding (inputting) the trap material into the device may be connected to the device via a connection member such as a valve, for example.

<Conditions>

The reaction temperature and reaction pressure during the modification reaction and the processing temperature and processing pressure during the trap processing may be appropriately configured depending on the type of solvent such that the temperature and the pressure of the solvent exceeds the critical temperature and critical pressure thereof, at which point the solvent can maintain a supercritical state. The temperature and pressure have no particular limitations, as long as the solvent can be maintained in a supercritical state. Examples of this include carbon dioxide at 304K, 7.38 MPa and above, and methanol at 512.6K, 8.09 MPa and above.

The modification reaction time may also be appropriately configured depending on the type of nanoparticles and modification agent such that the desired modification reaction is completed. The contact time with the trap material may also be appropriately configured depending on the type of trap material, modification agent, solvent, quantity used, and the like, such that impurities such as unreacted modification agent can be adsorbed onto the trap material.

In a similar manner, the proportion of nanoparticles to modification agent has no particular limitations, and may be appropriately configured depending on the type of nanoparticles used, the type of modification agent, and the like, such that the desired modified nanoparticles are obtained.

For the proportion of nanoparticles to modification agent, however, it is necessary to use a large excess of modification agent with respect to the nanoparticles, so that the modification reaction on the nanoparticle surfaces will be an interface reaction. If the amount of modification agent is too excessive, however, then it will become difficult to perform the process of removing the unreacted modification agent; therefore, it is preferable that this proportion be set at nanoparticles:modification agent=1:several hundred to several tens of thousands.

The amount of supercritical fluid has no particular limitations, as long as the modification agent can be sufficiently dissolved and the nanoparticles can be sufficiently immersed.

The trap material has no particular limitations, as long as the excess of the added modification agent can be trapped by the trap material. In any case, the total surface area of the added trap material should be able to sufficiently ensure that unreacted modification agent is adsorbed.

<Drying>

After the impurities have been removed by the trap material and the solvent has been removed by filtering or the like if necessary, as described above, the modified nanoparticles are dried to make it possible to collect the modified nanoparticles while in a powder-like form.

It is preferable that the drying be performed for a uniform amount of time under reduced pressure. This makes it possible to efficiently dry the modified nanoparticles. The depressurization condition has no particular limitations, as long as the solvent can be completely removed.

It is also possible to remove low boiling point impurities by performing the drying of the modified nanoparticles while applying heat, which makes it possible to obtain highly pure modified nanoparticles with few impurities.

According to the present embodiment, by trapping the impurities with the trap material in the supercritical fluid as described above, it is possible to obtain modified nanoparticles with an impurity rate of under 30%, as calculated by a pyrolysis-gas chromatography-mass spectrometry analysis method (hereinafter, “GC-Mass analysis”), regardless of whether or not the primary particle diameter is less than 100 nm. It is preferable that the impurity rate be under 20%, and even more preferably under 10% (technically, a modified nanoparticle composition having modified nanoparticles and impurities not bonded to the modified nanoparticles).

In other words, it is possible to obtain modified nanoparticles with a primary particle diameter of less than 100 nm having a purity of at least 70%, preferably at least 80%, and even more preferably at least 90%, as calculated by GC-Mass analysis.

According to the present embodiment, it is confirmed that there are almost no impurities by GC-Mass analysis of the modified nanoparticles, and that only the modification agent layer bonded to the nanoparticle surfaces is the primary peak.

<Uses>

The modified nanoparticles can have various uses as a composite material by being combined with base substances of polymers or the like to form composites, for example.

Conventionally, there have been many attempts to improve every aspect of certain substances, and polymers in particular, in order to improve the characteristics thereof.

In the case of organic polymers, however, it is known that it is difficult to achieve a high refractive index in practice, such as a refractive index of approximately 1.7-1.8 or above, for example.

It is also known from experience to one with ordinary skill in the art that even if a high refractive index is achieved, the Abbe number would fall, because the refractive index and reciprocal dispersion are in a trade-off relationship, which makes it very difficult to practically implement such a configuration.

In other words, improvements of polymers themselves are commonly known to have limits, and other strategies are required. A primary example of such a strategy is mixing other materials with a high refractive index with the polymers.

It is theoretically possible to predict what the approximate refractive index of a composite polymer will be as a whole if a certain amount of a substance with a certain refractive index is mixed with a polymer of a certain refractive index.

The problem, however, is whether or not this substance can be mixed with the polymer as theorized, and in practice this is normally difficult.

Such examples of this are widely prevalent, such as the effort being made to obtain several types of composite polymers with characteristics such as high permittivity, high thermal conductivity, heat resistance, resistance to ultraviolet rays, and the like, for example, but not being able to achieve satisfactory results.

The modified nanoparticles of the present embodiment, however, are mixed with polymers, which are the base substance, to manufacture solid or liquid composite polymers as a functional material having a functionality that exceeds conventional materials, for example.

Such a functional material can be used for optical members, heat transfer members, and the like, for example.

If the functional material is a polymer with a high refractive index, for example, then this polymer with a high refractive index can be used as a material for various types of lenses, for example.

In other words, the optical members described above include lenses and the like that are widely used in eyeglasses, cameras such as for mobile phones or digital cameras, CCDs (charge-coupled devices), and pickup such as optical discs, for example.

As described above, if a material with a high refractive index is able to be used for the lens material, than the focal length can be shortened more than if a conventional lens material were used; therefore, it is possible to increase the thinness and flatness of the lens (namely, make the surface rounder). There is also the advantage that if eyeglasses or the like using conventional glass were to switch to the optical member using the functional material described above, it would be possible to make the eyeglasses or the like very lightweight.

Additional examples of such optical members include light-diffusing material such as diffusion film and anti-reflection film and the like used in liquid crystal panels, for example.

If the functional material is a polymer with high thermal conductivity, for example, then this polymer with high thermal conductivity can be used as a material for printed circuit boards, heat dissipating plates, LED substrates or molding material, heat-exchange pipes for air conditioners, panels, and the like.

Thermal design has become very important as notebook PCs (personal computers), mobile devices, and the like become smaller by the year, for example. Namely, a mechanical design that efficiently removes heat generated in devices such as CPUs (central processing units) and the like is very important for the functionality of various devices.

In such applications, there is demand for improvements in the heat dissipating characteristics of the heat dissipating plates and the printed circuit boards themselves. Such a heat transfer member can be improved relatively simply by using metal materials, but most components are adversely affected when insulation becomes high, and thus, there are many cases where metal materials cannot be used.

There is aggressive demand for polymers with high thermal conductivity characteristics for the material of such a heat transfer member. It is also possible to make the heat transfer member more lightweight by using such polymers.

Suitable nanoparticles for achieving a high refractive index include titanium oxide, barium titanate, zinc oxide, and the like, for example.

Suitable nanoparticles for achieving high thermal conductivity include aluminum oxide, silicon nitride, aluminum nitride, and the like, for example.

When aiming for high permittivity, nanoparticles constituted of barium titanate, lead zirconate titanate, or the like are suitable, for example, and when aiming for high piezoelectric characteristics, nanoparticles constituted of barium titanate, other titanate, zirconate titanate (lead, etc.), niobate (potassium, lithium, etc.), tantalite (potassium, lithium, etc.), tungstate (sodium, etc.), zinc oxide, aluminum nitride, gallium phosphate, Rochelle salt, topaz, tourmaline, or the like are suitable, for example.

Suitable polymers as a base substance for providing flexibility include polyethylene, polypropylene, polyvinyl alcohol, a polyamide-based based polymer, polyethylene terephthalate, polyoxymethylene, or the like, for example.

Suitable polymers as a base substance for providing rigidity include aromatic polyamide, aromatic polyester, polyazomethine, or polymers with different node rings, for example.

When providing heat resistance, aromatic polyamide, aromatic polyether, aromatic polysulfide, polyimide, polyarylate, polyether ketone, polyether sulfone, or the like are preferable, for example. When providing shape-memory characteristics, polynorbornene, trans-polyisoprene, a styrene-butadiene block copolymer, polyurethane, or the like are preferable, for example. When providing transparency, polymethyl methacrylate, polystyrene, polycarbonate, or the like are preferable, for example.

The functional material having the modified nanoparticles described above and the various goods such as the optical members or the heat transfer members made of this functional material may be in liquid form or in solid form. The base substance for forming composites with the modified nanoparticles is not limited to polymers, and various types of liquid or solid substances can be used to form composites with the modified nanoparticles.

The modified nanoparticles or the functional material having these modified nanoparticles can be suitably used for the various uses described in Patent Documents 1 to 7 and Non-Patent Documents 1 to 3, for example, and can be suitably used for various other purposes.

### Embodiment 2

A coverage rate analysis device according to Embodiment 2 of the present invention will be explained with reference to FIGS. 1 and 2.

<Summary of Coverage Rate Analysis Device>

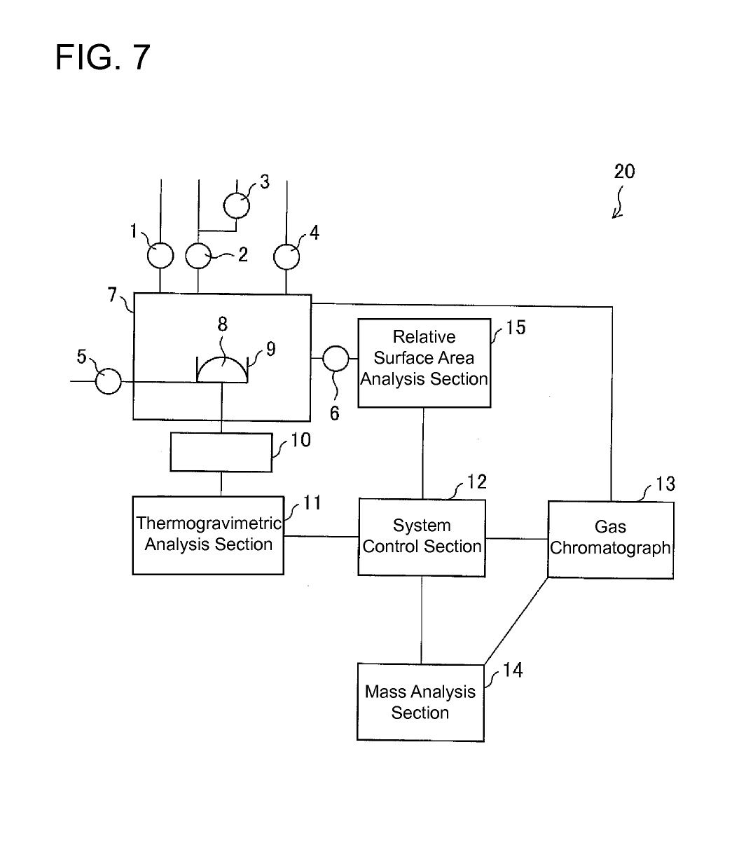

FIG. 7 is a schematic view of a coverage rate analysis device 20. The coverage rate analysis device 20 is a device that analyzes the coverage rate of a surface of a sample that has been modified with a modification material, the coverage rate expressing the proportion of area modified by this modification material.

The object of analysis for the coverage rate analysis device 20 is a substance whose surface has been modified by a modification material. In particular, powder or particle samples can be suitably analyzed. Hereinafter, the particle sample (particle) is referred to as simply a “sample.” The surface of the particle is also expressed as the surface of the sample. An example of a sample that can be analyzed by the coverage rate analysis device 20 is the silica particles and the like described in Embodiment 1. It is known that the particles analyzed by the coverage rate analysis device 20 have a concentration of reaction sites on the respective surfaces thereof.

The modification material modifying the particles bonds to the surfaces of the respective particles and modifies the surfaces thereof, and can change the characteristics of the samples that have been modified. An example of a modification material that modifies particles includes octadecyltrimethoxysilane (OTS). The molecular weight of the modification material modifying the particles is known.

As shown in FIG. 7, the coverage rate analysis device 20 includes a thermogravimetric analysis section 11, a relative surface area analysis section 15, which is part of a relative surface area analysis unit, and a system control section (control unit) 12. The coverage rate analysis device 20 may further include a furnace 7, a gas chromatograph 13, and a mass analysis section 14, and may include other analysis units. In the coverage rate analysis device 20, a thermogravimetric analysis unit is formed by the thermogravimetric analysis section 11, the gas chromatograph 13, and the mass analysis section 14.

In this manner, the coverage rate analysis device 20 is a single device that is capable of performing both thermogravimetric analysis and relative surface area analysis on samples constituted of particles. The coverage rate analysis device 20 calculates the coverage rate of the particles by the modification material on the basis of the mass of the modification material obtained by the thermogravimetric analysis performed by the thermogravimetric analysis unit and the relative surface area obtained by the relative surface area analysis performed by the relative surface area analysis section 15. The respective parts of the coverage rate analysis device 20 will be explained below.

<Furnace 7>

In the coverage rate analysis device 20, the furnace 7 internally holds a sample 8 constituted of the particle to be analyzed, and various analyses are executed inside the furnace 7. As shown in FIG. 7, the furnace 7 includes a sample holding part 9 that holds the sample 8. The sample 8 analyzed by the coverage rate analysis device 20 undergoes thermogravimetric analysis and relative surface area processing while being held by the sample holding part 9 in the furnace 7.

The furnace 7 is connected to various gas pipes so that different types of gases can be introduced into the furnace 7. The gases introduced into the furnace 7 can be a gas that is adsorbed onto the sample 8 when the relative surface area analysis is performed in the relative surface area analysis section 15, or an inert gas that serves as a carrier gas used during separation in the gas chromatograph 13. An example of this type of inert gas includes nitrogen (N₂) gas, helium (He) gas, argon (Ar) gas, and the like. The furnace 7 may also be configured such that oxygen (O₂) is introduced during ashing or oxidizing of the surface of the sample 8.

In the present embodiment, a case in which oxygen (O₂) gas, nitrogen (N₂) gas, and helium (He) are used will be explained as an example. In other words, the furnace 7 is connected to an oxygen gas pipe having an oxygen gas valve 1, a nitrogen gas pipe having a nitrogen gas valve 2, and a helium gas pipe having a helium gas valve 3. The furnace 7 is also connected to the gas chromatograph 13 through the pipes, and the gas introduced to the furnace 7 is also supplied to the gas chromatograph 13 through these pipes. When using inert gases such as Ar gas as the carrier gas, the Ar gas pipe and the argon gas valve may connect to the furnace 7.

In the present embodiment, it is assumed that the relative surface area analysis will be performed in an N₂ gas atmosphere or a mixed gas atmosphere of N₂ gas and He gas. Therefore, as shown in FIG. 7, the nitrogen gas valve 2 is disposed on the pipe closer to the furnace 7 than the junction of the nitrogen gas pipe and the helium gas pipe, and the helium gas valve 3 is disposed closer to the helium gas pipe than the junction of the nitrogen gas pipe and the helium gas pipe.

When the N₂ gas is introduced into the furnace 7, opening the nitrogen gas valve 2 while the helium gas valve 3 is closed makes it possible to introduce an N₂ gas of a prescribed flow rate and partial pressure, for example. When the gas mixture of N₂ gas and He gas is introduced into the furnace 7, opening the nitrogen gas valve 2 and the helium gas valve 3 allows for a gas mixture of N₂ gas and He gas at a prescribed flow rate and partial pressure to be introduced.

The gas introduced into the furnace 7 is not limited to the above-mentioned N₂ gas or the gas mixture of the N₂ gas and the He gas. If it is preferable that only the He gas be introduced into the furnace 7, for example, then the helium gas pipe may be directly connected to the furnace 7 and the helium gas valve 3 may be disposed on this pipe.

A vacuum pump (not shown) is connected to the furnace 7 via a decompression valve 4 in order to lower the pressure inside the furnace 7. A combination of a scroll pump and turbomolecular pump can be used as the vacuum pump, for example. The vacuum pump may be any configuration that is capable of lowering pressure inside the furnace 7 from atmospheric pressure to a desired degree of vacuum.

Although not shown, the furnace 7 includes a heating mechanism for heating the sample 8. This heating mechanism is for heating the sample when thermogravimetric analysis is being performed, and can heat the sample 8 to high temperatures such as 700° C., for example.

The furnace 7 is connected to the thermogravimetric analysis section 11 via a sealing mechanism 10, and connected to the relative surface area analysis section 15 through a valve 6. The sealing mechanism 10 seals off the inside of the furnace 7 from the outside thereof (namely, the atmosphere) and is connected to the sample holding part 9 and the thermogravimetric analysis section 11. With this configuration, thermogravimetric analysis of the sample 8 can be performed by the thermogravimetric analysis section 11 while the furnace 7 is sealed.

<Sample Holding Part 9>

The sample holding part 9 holds the sample 8 while the thermogravimetric analysis and the relative surface area analysis is being performed, and may also function as a scale for the thermogravimetric analysis section 11 to measure the mass of the sample 8.

It is preferable that the sample holding part 9 be constituted of a different substance than the substance forming the sample 8 and the modification material. If the sample holding part 9 is made of the sample substance as these substances, accurate analysis will not be possible due to the possibility that the mass of the substance forming the sample holding part 9 will be included in the mass obtained by the thermogravimetric analysis. It is preferable that the sample holding part 9 be constituted of a substance that does not react with the sample 8, modification material, and carrier gas. In the present embodiment, the sample holding part 9 is made of platinum.

The sample holding part 9 includes a cooling mechanism (cooling unit) for cooling the sample 8 when the relative surface area of the sample 8 is being measured by the relative surface area analysis section 15. More specifically, a pipe that allows circulation of liquid nitrogen, which is the cooling agent, is disposed at a location that at least partially connects with the sample holding part 8. One end of this pipe is connected to a liquid nitrogen tank (not shown) via a liquid nitrogen valve 5 disposed outside the furnace 7. The liquid nitrogen supplied from the liquid nitrogen tank to the sample holding part 9 via the liquid nitrogen valve 5 cools the sample 8 via the sample holding part 9. With this cooling mechanism, it is possible for the sample holding part 9 to cool the sample 8 to approximately the same temperature as liquid nitrogen.

<Thermogravimetric Analysis Section 11>

The thermogravimetric analysis section 11 measures the mass of the modification agent and provides the measurement results to the system control section 12 by performing thermogravimetric analysis on the sample 8 that has been modified by the modification material. Thermogravimetric analysis is a well-known measuring method in which the sample 8 is heated and the change in mass of the sample 8 due to this heating is measured, thereby measuring the mass of components that detach from the sample 8 due to the heating. Details of thermogravimetric analysis are disclosed in Reference Patent Document 1 (Japanese Patent Application Laid-Open Publication No. S61-213655), Reference Patent Document 2 (Japanese Patent Application Laid-Open Publication No. H6-300748), Reference Patent Document 3 (Japanese Patent Application Laid-Open Publication No. 2005-69792), and the like, which are included in the present specification for reference, for example.

The thermogravimetric analysis section 11 heats the sample 8 modified by the modification material through control from the system control section 12. The heating causes modification material modifying the surface of the sample 8 to detach from the sample 8 and turn into gas. When the sample 8 is a silica particle and the modification material is OTS, for example, then the OTS is detached from the silica particle by heating the sample 8 to 700° C. In other words, the reduction in the mass of the sample 8 due to heating the sample 8 from room temperature to 700° C. can be interpreted as being from the mass of the OTS modifying the surface of the sample 8. In this manner, the thermogravimetric analysis section 11 measures the mass of the modification material by measuring the mass of components that detach from the sample 8 due to heating.

The sample 8 is heated to a high temperature such as 700° C., for example, by the thermogravimetric analysis section 11. In other words, the components adsorbed onto the surface of the sample 8 detach. Accordingly, when thermogravimetric analysis has finished, the surface of the sample 8 is in a clean state in which the modification material and other adsorbed material (atmospheric moisture, impurities, and the like) are removed. In other words, by performing thermogravimetric analysis, an unmodified material constituted of clean particles can be obtained automatically.

A commercially available thermogravimetric analysis device may be used as the thermogravimetric analysis section 11. An example of such a thermogravimetric analysis device includes Thermoplus made by Rigaku Corporation.

The measuring of the mass of the sample 8 by the thermogravimetric analysis section 11 may be performed by placing the sample 8 on the sample holding part 9 functioning as a scale. In other words, while the sample 8 is on the sample holding part 9, it is possible to heat the sample 8 and have the sample holding part 9 measure the change in mass of the sample 8 caused by heating.

<Gas Chromatograph 13 and Mass Analysis Section 14>

The gas chromatograph 13 separates the components that have detached from the sample 8 due to thermogravimetric analysis by the thermogravimetric analysis section 11. As shown in FIG. 7, the gas chromatograph 13 is connected to the furnace 7 by a pipe. The gas chromatograph 13 is also connected to the mass analysis section 14, which is part of a mass analysis unit. The mass analysis section 14 analyzes the mass of various gases separated by the gas chromatograph 13.

During thermogravimetric analysis by the thermogravimetric analysis section 11, the sample 8 is heated and components that detach from the sample 8 are turned into gas, and this gas is introduced to the gas chromatograph 13 along with the carrier gas that has been introduced to inside the furnace 9. The gas chromatograph 13 separates the inserted gases and sequentially sends the respective isolated gases to the mass analysis section 14. The mass analysis section 14 analyzes the mass of the respective gases that have been isolated by the gas chromatograph 13, and measures the molecular weight of the respective measured gases.

There is a risk that other adsorbing materials, in addition to the modification material, could be adsorbed onto the surface of the sample 8. This other adsorbing material includes atmospheric moisture, impurities, and the like. The gases that detach from the sample 8 are separated by the gas chromatograph 13, and mass analysis clarifies the relationship between the changes in mass following the changes in temperature of the sample 8 and the gas components generated during the respective changes in mass. In other words, among the plurality of changes in mass, the change in mass caused by the modification material can be selectively extracted as a meaningful change in mass. Accordingly, with this configuration, it is possible to more accurately measure the mass of the modification material modifying the sample 8.

In the coverage rate analysis device 20, the thermogravimetric analysis unit is formed by the thermogravimetric analysis section 11, the gas chromatograph 13, and the mass analysis section 14. The coverage rate analysis device 20 measures the mass of the modification material on the basis of the respective measurement results from the thermogravimetric analysis section 11, the gas chromatograph 13, and the mass analysis section 14.

It is preferable that coverage rate analysis device 20 measure the mass of the modification material on the basis of the respective measurement results from the thermogravimetric analysis section 11, the gas chromatograph 13, and the mass analysis section 14, but the gas that detaches from the sample 8 may be directly introduced to the mass analysis section 14. Even if the coverage rate analysis device 20 does not separate the gas components that have detached due to the gas chromatograph 13, it is possible to obtain the mass of the modification material components as long as the plurality of changes in mass following temperature changes of the sample 8 and the plurality of gas components generated during the respective changes in mass are handled.

Furthermore, the coverage rate analysis device 20 may be a configuration that does not include the gas chromatograph 13 and the mass analysis section 14. If there is only a very small amount of mass from other adsorbing materials with respect to the mass of the modification material modifying the sample 8, then it is possible to attribute all of the changes in mass of the sample 8 due to thermogravimetric analysis to changes in mass of the modification material.

<Relative Surface Area Analysis Section 15>

The relative surface area analysis section 15, which is a part of a relative surface area analysis unit, measures the relative surface area of the unmodified sample 8 that is not modified by the modification material. The relative surface area analysis section 15 is a well-known relative surface area analysis method to measure relative surface area, such as the BET method, for example. The relative surface area analysis section 15 is connected to the furnace 7 through the valve 6. In other words, the relative surface area analysis section 15 connects with the furnace 7 by the valve 6 being opened, making it possible to perform relative surface area analysis on the sample 8.

In the present embodiment, the relative surface area analysis section 15 measures relative surface area by an ordinary BET method for the method of relative surface area analysis. The BET method causes an inert gas (N₂ gas, or a gas mixture of N₂ gas and He gas, for example) to be adsorbed onto the surface of the sample 8, and measures the relative surface area of the sample 8 by measuring the adsorption amount of the inert gas.

When the inert gas is adsorbed onto the surface of the sample 8, the sample 8 is sufficiently cooled in order to reliably adsorb the inert gas onto the surface of the sample 8. The cooling of the sample 8 during relative surface area analysis is performed by the cooling mechanism of the sample holding part 9, which is where the sample 8 is held. The temperature of the liquid nitrogen circulating through the pipe of the cooling mechanism may cool the sample 8 by being a sufficiently low enough temperature to cause the inert gas to be adsorbed onto the surface of the sample 8, for example.

In this manner, gas is adsorbed onto the of the unmodified sample 8 surface that has been cooled in the presence of the inert gas. The inert gas that has been adsorbed onto the surface of the unmodified sample 8 surface detaches from the surface of the sample 8 when the sample 8 returns to room temperature. The relative surface area analysis section 15 measures the relative surface area of the unmodified sample 8 by measuring the amount of the detached inert gas. These measurement results are then sent to the system control section 12.

A commercially available relative surface area analysis device may be used for the relative surface area analysis section 15. An example of such a relative surface area analysis device includes the Autosorb-1-C made by Quantachrome.

<System Control Section 12>

The system control section 12 is part of a control unit that controls the respective sections of the coverage rate analysis device 20. Specifically, the system control section 12 performs thermogravimetric analysis by controlling the thermogravimetric analysis section 11, performs relative surface area analysis by controlling the relative surface area analysis section 15, and performs mass analysis by controlling the gas chromatograph 13 and the mass analysis section 14.

The system control section 12 controls the opening and closing of the oxygen gas valve 1, the nitrogen gas valve 2, the helium gas valve 3, the decompression valve 4, the liquid nitrogen valve 5, and the valve 6 as necessary.

The flow rate and partial pressure of O₂ gas introduced into the furnace 7 is determined by the system control section 12 controlling the oxygen gas valve 1, for example. In a similar manner, the flow rate and partial pressure of N₂ gas introduced into the furnace 7 is determined by the system control section 12 controlling the nitrogen gas valve 2, and the flow rate and partial pressure of He gas introduced into the furnace 7 is determined by the system control section 12 controlling the helium gas valve 3.

The system control section 12 also controls the temperature of the sample 8 by controlling the heating mechanism of the furnace 7 and the cooling mechanism of the sample holding part 9.

The system control section 12 controls the heating mechanism of the furnace 7 on the basis of a temperature profile, for example. This temperature profile may be a temperature profile that is stored in a memory section of the system control section 12 in advance, or may be a temperature profile that is configured by the user when performing thermogravimetric analysis. An example such a temperature profile includes a rate of temperature increase of 20° C./minute from room temperature until 700° C. This rate of temperature increase can be appropriately configured on the basis of the characteristics of the sample 8, the characteristics of the modification material, and the required time for thermogravimetric analysis, for example.

When the sample 8 and the sample holding part 9 are to be cooled in order to cause the inert gas to be adsorbed onto the sample 8, the system control section 12 may be configured to open the liquid nitrogen valve 5 at this time, for example. After the inert gas has been adsorbed onto the sample 8, the system control section 12 may be configured to close the liquid nitrogen valve 5 when the sample 8 and the sample holding part 9 are to be returned to room temperature, for example.

The system control section 12 is part of a control unit that controls the coverage rate analysis device 20 and is also a part of a computation unit that calculates the coverage rate.

When it is known in advance that the modification material is OTS and that the molecular weight of the OTS is 297, the system control section 12 divides the mass of the modification material as obtained by thermogravimetric analysis with the molecular weight of the modification material, for example. In this manner, the system control section 12 calculates the number of molecules of the modification material that modifies the sample 8. In other words, the system control section 12 is also a part of a modification material molecule number calculation unit.

The system control section 12 also calculates the number of reaction sites of the sample 8 from the relative surface area of the unmodified sample 8 as measured by the relative surface area analysis section 15. In other words, the system control section 12 is also a part of a reaction site number calculation unit.

The system control section 12 calculates the coverage rate of the sample 8 by the modification material as the ratio of the calculated number of reaction sites of the sample 8 to the number of molecules of the modification material.

In this manner, the system control section 12 directly measures the mass of the modification material modifying the sample 8 by thermogravimetric analysis and calculates the number of molecules of this modification material on the basis of the mass of the modification material. Accordingly, it is possibly to accurately find the number of molecules of the modification material modifying the sample 8. As a result, the coverage rate of the sample 8, which is calculated on the basis of the number of molecules of the modification material, can be accurately found.

The system control section 12 may be configured such that the relative surface area of the unmodified sample 8 is measured by the relative surface area analysis section 15 after the mass of the modification material has been measured by the thermogravimetric analysis section 11. After the thermogravimetric analysis, the sample 8 turns into an unmodified state due to the modification material detaching due to heat, and the relative surface area analysis can be performed in this state. This results in shortening the coverage rate analysis process.

<Coverage Rate Analysis Flow>

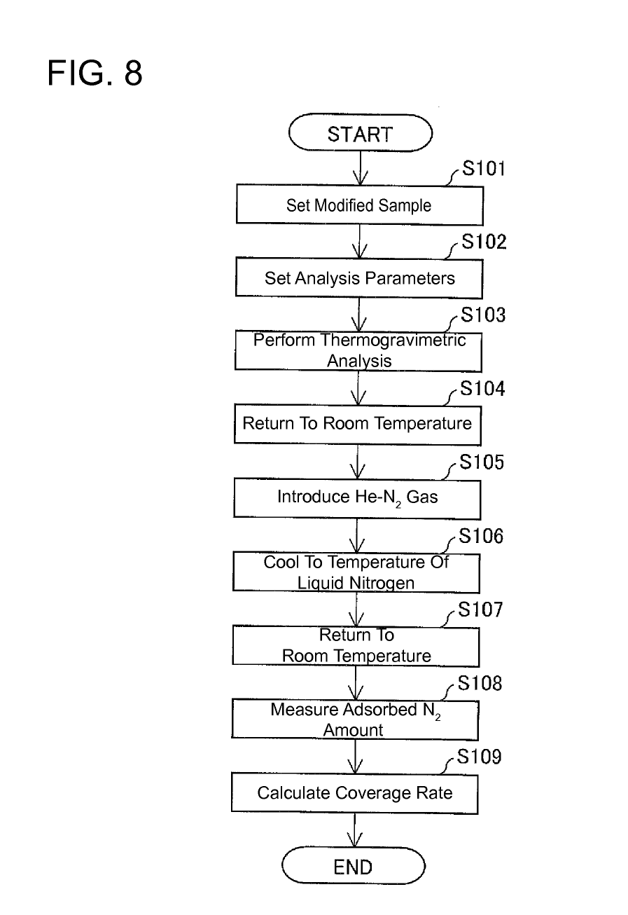

A method of coverage rate analysis according to Embodiment 2 of the present invention will be described using the above-mentioned coverage rate analysis device 20 as an example. The flow of the coverage rate analysis using the coverage rate analysis device 20 will be described with reference to FIG. 8. FIG. 8 is a view of the process flow of the coverage rate analysis device according to Embodiment 2 of the present invention. A silica particle being modified by OTS will be described as one example of the sample 8 in the present embodiment. It is preferable that the sample 8 be purified after being modified by the modification material.

Step S101: set the sample 8 modified by the modification material in the sample holding part 9.

Step S102: configure analysis conditions for when thermogravimetric analysis is performed. These analysis conditions are similar to the analysis conditions when performing ordinary thermogravimetric analysis. In other words, the temperature profile (the degree to which the sample will be heated and with what rate of temperature increase) and the like can be set as the analysis conditions for when the sample 8 is heated. The analysis conditions of a relative surface area analysis step, described later, may also be set in this step.

Step S103: have the thermogravimetric analysis section 11 run thermogravimetric analysis under the configured analysis conditions. The thermogravimetric analysis section 11 measures the mass of the sample 8 heated to a prescribed temperature by the heating mechanism in the furnace 7, the mass having changed due to the heating. The thermogravimetric analysis section 11 sends the mass of the modification material that has detached from the surface of the sample 8 by heating as the change in mass of the measured sample 8 to the system control section 12.

Step S104: return temperature of the sample 8 to room temperature by stopping the heating of the sample 8 by the heating mechanism.

The series of steps from step S101 to step S104 is described as the thermogravimetric analysis step. After the thermogravimetric analysis step, the sample 8 is in an unmodified state due to the modification material that was modifying the surface being detached by the heating.

Step S105: introduce inert gas into the furnace 7 after the thermogravimetric analysis step has finished. The system control section 12 causes a gas mixture of He gas and N₂ gas to be introduced into the furnace 7 by opening the nitrogen gas valve 2 and the helium gas valve 3, for example.

Step S106: cool the sample 8 by opening the liquid nitrogen valve 5 and allowing liquid nitrogen to circulate through the pipe. Due to the cooling, the N₂ molecules are adsorbed onto the surface of the sample 8 in the furnace 7 in which the N₂ gas has been introduced.

Step S107: return the sample 8 to room temperature by closing the liquid nitrogen valve 5 and stopping the circulation of liquid nitrogen.

Step S108: have the relative surface area analysis section 15 measure the relative surface area of the sample 8 on the basis of the amount of N₂ molecules (N₂ adsorption amount) adsorbed onto the sample 8 and send the measured relative surface area to the system control section 12.

The series of steps from step S105 to step S108 is described as the relative surface area analysis step.

Step S109: have the system control section 12 calculate the coverage rate of the sample 8 on the basis of the mass of the modification agent obtained in the thermogravimetric analysis step and the relative surface area of the unmodified-state sample 8 obtained in the relative surface area analysis step. In other words, step S109 is a calculating step in which the coverage rate of the sample 8 is calculated.

Specifically, the system control section 12 calculates the number of molecules of the modification material modifying the sample 8 by dividing the mass of the modification material obtained in the thermogravimetric analysis step by the molecular weight of the modification material.

The system control section 12 also divides the relative surface area of the unmodified-state sample 8 obtained in the relative surface area analysis step by the concentration of reaction sites on the surface of the sample 8. This division allows the system control section 12 to calculate the number of reaction sites on the unmodified-state sample 8. In the present embodiment, “reaction site” means the functional groups to which the modification material binds or is adsorbed onto on the surface of the sample 8. If the sample 8 is silica, then the reaction site is SiOH present on the outermost surface of the silica. Furthermore, “concentration” of the reaction sites means the density of the reaction sites distributed on the surface of the sample 8. If the sample 8 is a silica particle, then the concentration of the reaction sites (SiOH) is 25×10⁻²⁰ m² (25 Å²) per particle.

The system control section 12 calculates the rate of modification material to reaction sites by dividing the number of molecules of the modification material obtained in the above-mentioned operations by the number of reaction sites on the sample 8. This ratio of modification material to reaction sites is equal to the coverage rate of the sample 8 modified by the modification material.

The coverage rate of the sample 8 modified by the modification material is calculated as described above.

In the present embodiment, thermogravimetric analysis and relative surface area analysis of the sample 8 may be performed after step S109.

According to the present embodiment, thermogravimetric analysis is performed on the sample 8 modified by the modification material and the mass of the modification material modifying the sample 8 is measured. Accordingly, it is possible to accurate analyze the mass of the modification material. The relative surface area of the unmodified sample 8 is measured, and the coverage rate of the sample 8 modified by the modification material is measured on the basis of this relative surface area and the mass of the modification material; therefore, it is possible to accurately calculate the coverage rate.

In the present embodiment, first the thermogravimetric analysis is performed, and then after that the relative surface area analysis is performed. With this configuration, the modification material modifying the sample 8 and other adsorbed material are detached from the surface of the sample 8 when the thermogravimetric analysis is finished (at step S104). In other words, it can be said that the sample 8 automatically becomes a clean unmodified-state by running the thermogravimetric analysis. Thus, there is no need to perform processes on the sample 8 for relative surface area analysis, and the sample 8 after thermogravimetric analysis can be used in that state for relative surface area analysis. This results in simplifying the coverage rate analysis process.

The sample 8 is sufficiently dry when the thermogravimetric analysis ends. Accordingly, when performing ordinary relative surface area analysis, it is possible to omit required pre-drying steps as pretreatment. It is ordinary for this pre-drying step to include heating of the sample and a purge of atmospheric gas, which requires a long time, such as several hours to a day. With the configuration described above, the coverage rate analysis device 20 and the method of coverage rate analysis of the present embodiment can substantially shorten the time needed to analyze the coverage rate. A decrease in costs will also follow this ability for the required time of coverage rate analysis to be shortened.

In the present embodiment, it is possible to consecutively analyze the same sample after step S109 by performing thermogravimetric analysis and relative surface area analysis on the sample 8, thereby improving accuracy of the analysis.

In the coverage rate analysis device 20 of the present embodiment, the sample holding part 9 includes a cooling mechanism that can cool the sample 8, and thus, the sample 8 does not move from the sample holding part 9, which makes it possible to perform relative surface area analysis without exposing the sample 8 to the atmosphere. In this manner, the sample 8, which is clean prior to performing the relative surface area analysis, will not need to be exposed to the atmosphere; therefore, there is no risk that atmospheric moisture or impurities will attach to the surface of the sample 8. Accordingly, it is possible to eliminate the causes of reduced analytical accuracy in the relative surface area analysis.

### Embodiment 3

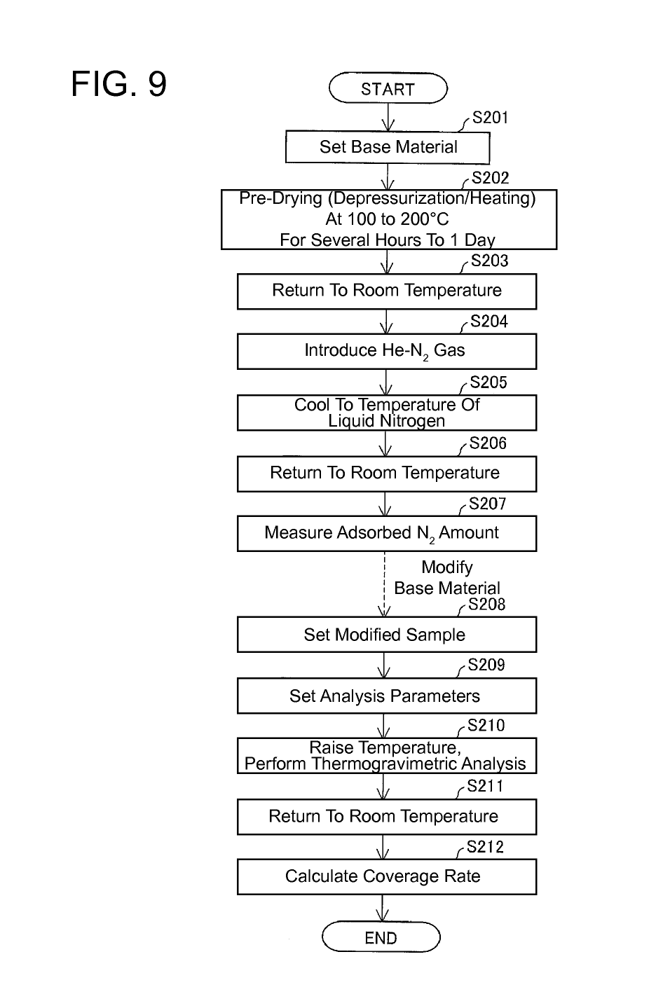

Embodiment 3 of the present invention will be explained with reference to FIG. 9. The coverage rate analysis device 20 will also be used in the present embodiment. The present embodiment differs from Embodiment 1 in that thermogravimetric analysis is performed first after relative surface area analysis.

Step S201: set an unmodified-state sample 8 in the sample holding part 9.

Step S202: pre-dry the sample 8. Specifically, the sample 8 is heated to 100° C. to 200° C. by the heating mechanism in the furnace 7. An appropriate temperature may be selected depending on the sample for the sample temperature in this pre-drying process. The pre-drying step may be performed while the furnace 7 is depressurized or may be performed while atmospheric gas is being purged.

Step S203: return the sample 8 to room temperature by stopping the heating of the sample 8 by the heating mechanism.

Step S204: introduce inert gas into the furnace 7 and make the inside of the furnace 7 a prescribed pressure. The system control section 12 causes a gas mixture of He and N₂ to be introduced into the furnace 7 by opening the nitrogen gas valve 2 and the helium gas valve 3, for example.

Step S205: cool the sample 8 by opening the liquid nitrogen valve 5 and allowing liquid nitrogen to circulate in the pipe. Due to the cooling, the N₂ molecules are adsorbed onto the surface of the sample 8 in the furnace 7 in which the N₂ gas has been introduced.

Step S206: return the sample 8 to room temperature by closing the liquid nitrogen valve 5 and stopping the circulation of liquid nitrogen.

Step S207: have the relative surface area analysis section 15 measure the relative surface area of the sample 8 on the basis of the amount of N₂ molecules adsorbed onto the sample 8 and send the measured relative surface area to the system control section 12.

The series of steps from step S201 to step S207 is described as the relative surface area analysis step. When the relative surface area analysis step is finished, the unmodified-state sample 8 is taken from the coverage rate analysis device 20 and modified with the modification material. After being modified by the modification material, the sample 8 is purified.

Step S208: set the sample 8 modified by the modification material in the sample holding part 9.

Step S209: set analysis conditions for when thermogravimetric analysis is performed. The analysis conditions are similar to those in Embodiment 1.

Step S210: have the thermogravimetric analysis section 11 run thermogravimetric analysis under the configured analysis conditions. The thermogravimetric analysis section 11 measures the mass of the sample 8 heated to a prescribed temperature by the heating mechanism in the furnace 7, the mass having changed due to the heating. The thermogravimetric analysis section 11 sends the mass of the modification material that has detached from the surface of the sample 8 by heating as the change in mass of the measured sample 8 to the system control section 12.

Step S211: return temperature of the sample 8 to room temperature by stopping the heating of the sample 8 by the heating mechanism.

The series of steps from step S208 to step S211 is described as the thermogravimetric analysis step.

Step S212: have the system control section 12 calculate the coverage rate of the sample 8 on the basis of the relative surface area of the unmodified-state sample 8 obtained in the relative surface area analysis step and the mass of the modification material obtained in the thermogravimetric analysis step. The step of the system control section 12 calculating the coverage rate is similar to step S109 in Embodiment 1.

Through these steps described above, the coverage rate analysis device 20 and the method of coverage rate analysis of Embodiment 3 of the present invention calculates the coverage rate of the sample 8 modified by the modification material.

### WORKING EXAMPLES

The present invention will be specifically described using working example and comparison examples below, but the present invention is not limited to only these working examples and comparison examples below.

In the working examples, mainly a case in which a silane-coupling agent covering nanoparticle surfaces is described as an example, but needless to say, the purification process of the present embodiment can be applied to the purification processes of modified nanoparticles used in the modification reactions in Patent Documents 1-6 and Non-Patent Documents 1-3, for example, as described above. The modification reactions themselves and the combination of nanoparticles, modification agents, solvents, and the like used in these modification reactions have no particular limitations.

### Working Example 1

### Modification Reaction

First, 30 mg of nanosilica having a primary particle diameter of 30 nm as the nanoparticles, 11.6 μL (liters) of octadecyltrimethoxysilane as the modification agent, and 16 g of liquid carbon dioxide (liquid CO₂) as the solvent are prepared and sealed into a 50 mL autoclave. The “High-Pressure Microreactor—MMS-50” (product name) made by Omlab Co., Ltd. was used for the autoclave.

Next, modified nanosilica were fabricated as products (modified nanoparticles) by heating the reaction liquid inside the autoclave to 40° C. and setting the pressure to 7.3 MPa, and running the reaction for 0.5 hours with the liquid CO₂ in a supercritical state. Thereafter, normal temperature and normal pressure were returned to.

<Capture of Impurities>

Next, 300 g of silica having a diameter of 65 μm was added into the autoclave as dummy silica (trap material), and then the autoclave was re-sealed, heated to 40° C. and pressure set at 7.3 MPa, and the reaction was run for 0.5 hours with the liquid CO₂ in a supercritical state. Thereafter, normal temperature and normal pressure were returned to.

<Removal of Impurities>

Next, the reacted products inside the autoclave were filtered with a PVDF (polyvinylidene difluoride) filter having a hole diameter of 200 nm using methanol and chloroform as the cleaning liquid.

<Drying>

Thereafter, the filtered liquid that had passed through the PVDF filter was dried in a depressurized environment for 8 hours at normal temperature and 1×10⁻² MPa, thereby collecting the modified silica as powder.

<Analysis>

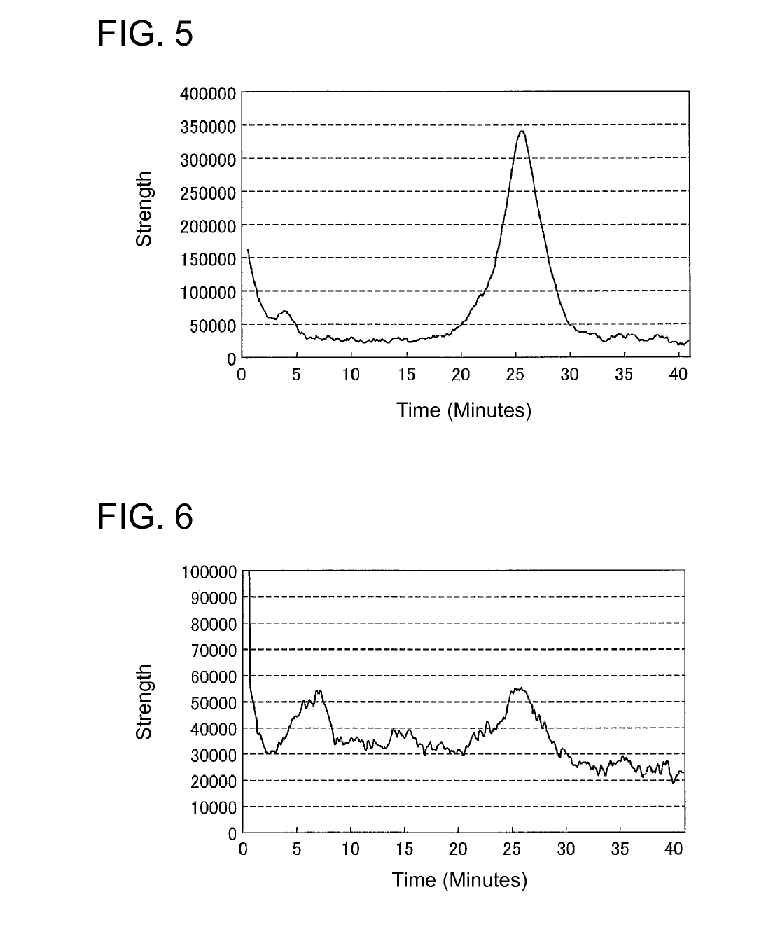

The ionic strength of the obtained products was measured between 50-800° C. by using a hollow column to increase temperature by 20° C./minute in a gas chromatography-mass spectrometry analysis device (hereinafter, “GC-Mass” device). For the GC-Mass device, a configuration was used in which the “GCMS-QP2010” made by Shimadzu Corporation was connected to the “PY-2020” made by Frontier Laboratories Ltd. The decomposition GC chart (hereinafter, “GC chart”) obtained by this is shown in FIG. 5.

As seen from the analysis results shown in FIG. 5, the small peak seen at under 100° C. until 5 minutes after the increase in temperature began shows the low boiling point impurities of waters and other impurities (such as methanol), and the large peak seen from 400 to 600° C. at 20-30 minutes after the increase in temperature shows the modification agent bonded to the nanosilica surface.

When there is unreacted modification agent present, the unreacted modification agent peak exists between 250 to 400° C., as shown in FIG. 6, described later. In FIG. 4, it is understood that there are virtually no other verifiable peaks other than the small peak at below 100° C. and the large peak at 400 to 600° C., which means that there is hardly any unreacted modification agent present.

The purity derived from the peak surface area of the GC chart shown in FIG. 5 is 92.5%, which shows that modified nanosilica having a very high purity with very few impurities has been obtained.

### Working Example 2

### Modification Reaction and Capture of Impurities

Working Example 2 is different from Working Example 1 in that 1.2 g of glass wool is added instead of dummy silica as the trap material in the <Capture of Impurities> step, which is the initial stage of the purification process. Besides this, the reactions and operations performed were similar to Working Example 1.

Namely, after the modification reaction is performed in a manner similar to Working Example 1, the autoclave returned to a normal temperature and normal atmosphere, 1.2 g of glass wool was added, the autoclave was re-sealed, and heat and pressure were increased to 40° C. and 7.3 MPa, respectively, to turn the liquid CO₂ into a supercritical state. The reaction was run for 0.5 hours under these conditions. Thereafter, normal temperature and normal pressure were returned to.

<Removal of Impurities>

Thereafter, the glass wool is removed from the reaction liquid, thereby removing the glass wool and any impurities trapped by the glass wool from the system.

<Drying>

Next, for comparison, this reaction liquid was divided into two portions, one of which was dried under reduced pressure in a manner similar to Working Example 1 to collect powder-like modified nanosilica as product (I). The other portion was dried by heat for 5 minutes at 150° C. under a reduced pressure of 1×10⁻² MPa in a desiccator through a vacuum pump, thereby collecting powder-like modified nanosilica as product (II).

<Analysis>

The ionic strength of the obtained product (I) was measured between 50 to 800° C. by using a GC-Mass device to increase the temperature by 20° C./minute, in a manner similar to Working Example 1.

As a result, a small peak was confirmed below 100° C. and a large peak was confirmed from 400 to 600° C., but there were no other obvious peaks aside from these, in a manner similar to Working Example 1. Thus it was confirmed that there was hardly any unreacted modification agent present.

It was understood that the purity of the product (I) derived from the peak surface area in the GC chart was 92.8% and that modified nanosilica with a very high degree of purity and very few impurities had been obtained.

The ionic strength of the obtained product (II) was measured between 50 to 800° C. by using a GC-Mass device to increase the temperature by 20° C./minute, in a manner similar to product (II).

As a result, the small peak under 100° C. in the GC chart of product (I) completely disappeared.

Thus, it was confirmed that in the <Drying> step after removal of the trap material, low boiling point impurities can also be removed by drying the modified nanoparticles by heating.

It was understood that the purity of the product (II) derived from the peak surface area in the GC chart was 93.6% and that it is possible to further increase purity by drying with heating after the trap material is removed, thereby obtaining nanosilica with a very high degree of purity and very few impurities.

### Working Example 3

### Modification Reaction

In a reaction vessel, in a manner similar to Working Example 1, 30 mg of nanosilica having a primary particle diameter of 30 nm, 11.6 μL of octadecyltrimethoxysilane, and 16 g of liquid CO₂ were prepared and sealed into an autoclave similar to that in Working Example 1 using a 3 cm diameter and 25 cm length silica column through a valve that was closed while the above was inserted. The temperature and pressure were then increased in 40° C. and 7.3 MPa, respectively, and the reaction was run for 0.5 hours with the liquid CO₂ in a supercritical state.

<Capture of Impurities> and <Removal of Impurities>

After the reaction, the inside of the autoclave was returned to normal temperature and pressure, the valve was opened, and the reaction liquid (supercritical CO₂ having modified nanosilica as the product) was introduced into the silica column. By passing this reaction liquid through the inside of the silica column through pressurization, the impurities in the system were trapped and removed by the silica particles inside the silica column. Thereafter, the reaction liquid was returned to a normal temperature and pressure state.

<Drying>

Next, this reaction liquid was dried by heating under reduced pressure to collect the modified nanosilica in a powder-like form.

<Analysis>

The ionic strength of the obtained product was measured between 50-800° C. by increasing the temperature by 20° C./minute using a GC-mass device, in a manner similar to Working Example 1.

As a result, a small peak was confirmed below 100° C. and a large peak was confirmed from 400 to 600° C., but there were no other obvious peaks aside from these, in a manner similar to Working Example 1. Thus it was confirmed that there was hardly any unreacted modification agent present.

It was understood that the purity of the product derived from the peak surface area in the GC chart was 95.7% and that modified nanosilica with a very high degree of purity and very few impurities had been obtained.

### Comparison Example 1

### Modification Reaction

20 mg of nanosilica having a primary particle diameter of 30 nm as the nanoparticles, 12.15 μL of octadecyltrimethoxysilane as the modification agent, and 16 mL of methanol as the solvent were put into a 200 mL flask and a Liebig condenser was connected upright with this flask. The modification reaction of the nanosilica was performed by stifling the reaction liquid with a magnetic stirrer while introducing nitrogen gas and performing reflux for 1 hour at 90° C.

<Removal of Impurities>

After the reaction was finished, the reaction liquid was filtered with a PVDF film similar to that in Working Example 1 while using methanol and chloroform as the cleaning liquid.

Thereafter, ultracentrifugation was performed for 1 hour at 20,000 rpm using methanol and chloroform.

<Drying>

Thereafter, the obtained precipitate was dried under reduced pressure to collect modified nanosilica in a powder-like form, in a manner similar to Working Example 1.

<Analysis>

The ionic strength of the obtained product was measured between 50-800° C. by increasing the temperature by 20° C./minute using a GC-mass device, in a manner similar to Working Example 1. The resulting GC chart is shown in FIG. 6.

From the analysis results shown in FIG. 6, it can be confirmed that a large peak is seen at 400 to 600° C., similar to Working Examples 1 to 3, and that this peak is derived from the modification agent bonding to the nanosilica surface.

There was also a large peak at 50 to 150° C. occurring 2.5 to 7.5 minutes after the start of increase in temperature, and a small peak at 250 to 400° C. occurring 12.5 to 20 minutes after the start of increase in temperature, which were not seen in Working Examples 1 to 3.

The large peak at 50 to 150° C. includes the peak below 100° C. seen in Working Examples 1 to 3, and this indicates that this large peak includes low boiling point impurities such as water and methanol and also other low boiling point components.

Meanwhile, the small at 250 to 400° C. shows the unreacted (not bonded to the nanosilica surface) modification agent that has entered between the aggregate of modified nanoparticles.

It was also confirmed that the purity derived from the peak surface area in the GC chart shown in FIG. 6, which is clearly lower than the modified nanoparticles obtained in Working Examples 1 to 3.

### Working Example 4

### Modification Reaction

Working Example 4 differs from Working Example 1 in that 30 mg of titanium oxide (TiO₂) having a primary particle diameter of 30 nm was used as the nanoparticles and 11.6 μL of dimethoxydiphenylsilane was used as the modification agent. Besides this, similar operations to Working Example 1 were performed in order to manufacture modified titania as the product (modified nanoparticles).

<Capture of Impurities>

Next, in a manner similar to Working Example 1, 30 ng of silica having a 65 μm diameter was added as trap material into the autoclave used for the modification reaction. The autoclave was then re-sealed, the temperature and pressure were increased to 40° C. and 7.3 MPa, respectively, and the reaction was run for 0.5 hours with the liquid CO₂ in a supercritical state. Thereafter, normal temperature and normal pressure were returned to.

<Removal of Impurities> to <Drying>

Next, the reacted product inside the autoclave was filtered with a PVDF filter, in a manner similar to Working Example 1, and the filtered liquid was dried under reduced pressure in a manner similar to Working Example 1 in order to collect modified titania in a powder-like form.

<Analysis>

The obtained product was analyzed with a GC-Mass device, in a manner similar to Working Example 1. This confirmed that there was hardly any unreacted modification agent present. It was understood that the purity of the product derived from the peak surface area in the GC chart was 97.0% and that modified titania with a very high degree of purity and very few impurities had been obtained.

<Manufacture of High Refractive Index Polymer Film (Optical Member)>

Thereafter, 1.3 g of divinylbenzene as the monomer, 0.026 g of AIBN (α,α′-azobisisobutyronitrile) as a polymerization initiator, 0.1 L of butyl acetate as the solvent, and modified titania in an amount equivalent to 50 wt % of the monomer was prepared in a reaction vessel, and this was mixed and polymerized for 18 hours at 100° C. to manufacture a composite polymer in which the modified titania was dispersed in the polydivinylbenzene and butyl acetate.

Next, this composite polymer was spin coated onto a silicon substrate and dried for 2 hours at 120° C., thereby manufacturing a composite polymer thin-film with a film thickness of 5 μm.

The obtained composite polymer thin-film (film thickness: 5 μm) was colorless and transparent, with a refractive index of 1.83. Therefore, according to the present working example, it was understood that it is possible to obtain a composite polymer having a high refractive index by using modified nanoparticles.

### Working Example 5

### Modification Reaction

Working Example 5 differs from Working Example 4 in that 11.6 μL of aminopropyltrimethoxysilane was used as the modification agent. Besides this, similar operations to Working Example 4 were performed to manufacture modified titania as the product (modified nanoparticles).

<Capture of Impurities> to <Drying>

Next, in a manner similar to Working Example 4, <Capture Of Impurities>, <Removal Of Impurities>, and <Drying> was performed to collect modified titania in a powder-like form.

<Analysis>

The obtained product was analyzed with a GC-Mass device, in a manner similar to Working Example 4. This confirmed that there was hardly any unreacted modification agent present. It was understood that the purity of the product derived from the peak surface area in the GC chart was 95.4% and that modified titania with a very high degree of purity and very few impurities had been obtained.

<Manufacture of High Refractive Index Polymer Film (Optical Member)>

Thereafter, 1.88 g of cyanuric chloride and 2.27 g of 4,4-diaminobenzanilide as monomers, and modified titania in an amount approximately equivalent to 50 wt % of the monomers was prepared in a reaction vessel, and this was mixed and polymerized for 12 hours at 90° C. to manufacture a composite polymer in which the modified titania was dispersed in the copolymer of cyanuric chloride and 4,4-diaminobenzanilide.

Next, this composite polymer was spin coated onto a silicon substrate and dried for 1 hour at 90° C., thereby manufacturing a composite polymer thin-film with a film thickness of 5 μm.

The obtained composite polymer thin-film (film thickness: 5 μm) was colorless and transparent, with a refractive index of 2.15. Therefore, according to the present working example, it was understood that it is possible to obtain a composite polymer having a high refractive index by using modified nanoparticles.

### Working Example 6

### Modification Reaction

Working Example 6 differs from Working Example 1 in that 30 mg of aluminum oxide (Al₂O₃) having a primary particle diameter of 30 nm was used as the nanoparticles, and 11.6 μL of dimethoxydiphenylsilane was used as the modification agent. Besides this, similar operations to Working Example 1 were performed to manufacture modified alumina as the product (modified nanoparticles).

<Capture of Impurities>

Next, in a manner similar to Working Example 1, 30 ng of silica having a 65 μm diameter was added as trap material into the autoclave used for the modification reaction. The autoclave was then re-sealed, the temperature and pressure were increased to 40° C. and 7.3 MPa, respectively, and the reaction was run for 0.5 hours with the liquid CO₂ in a supercritical state. Thereafter, normal temperature and normal pressure were returned to.

<Removal of Impurities> to <Drying>

Next, the reacted product inside the autoclave was filtered with a PVDF filter, in a manner similar to Working Example 1, and dried under reduced pressure in a manner similar to Working Example 1 in order to collect modified alumina in a powder-like form.

<Analysis>

The obtained product was analyzed with a GC-Mass device, in a manner similar to Working Example 1. This confirmed that there was hardly any unreacted modification agent present. It was understood that the purity of the product derived from the peak surface area in the GC chart was 96.4% and that modified alumina with a very high degree of purity and very few impurities had been obtained.

<Manufacturing of Highly Heat Conductive Polymer Piece (Heat Transfer Member)>

Thereafter, 1.3 g of divinylbenzene as the monomer, 0.026 g of AIBN as the polymerization initiator, 0.1 L of butyl acetate as the solvent, and modified alumina in an amount equivalent to 50 wt % of the monomer was prepared in a reaction vessel, and this was mixed and polymerized for 18 hours at 100° C. to manufacture a composite polymer in which the modified alumina was dispersed in the polydivinylbenzene and butyl acetate.

Next, this composite polymer was spin coated onto a silicon substrate and dried for 2 hours at 120° C. to manufacture a composite polymer piece with a diameter of 1 cm and a thickness of 1 mm.

The obtained composite polymer piece was colorless and transparent, with a thermal conductivity of 4.5 W/mk. Therefore, according to the present working example, it was understood that it is possible to obtain a composite polymer having high heat conductivity by using modified nanoparticles.

The present invention is not limited to the above-mentioned embodiments and working examples, and various modifications can be made without departing from the scope of the claims. That is, embodiments and working examples obtained by combining techniques modified without departing from the scope of the claims, embodiments, and respective working examples are also included in the technical scope of the present invention.

### Working Example 7

The coverage rate was analyzed using thermogravimetric analysis and relative surface area analysis.

<Sample Modification>

Silica particles having an average particle diameter of 200 nm were used as the sample, and OTS was used as the modification material. 2.5 g of silica particles, 50 μl of OTS, and 100 ml of xylene were prepared in a 200 ml flask having a Dimroth condenser. This was stirred while being heated to 100° C., thereby modifying the surface of the silica particles with OTS.

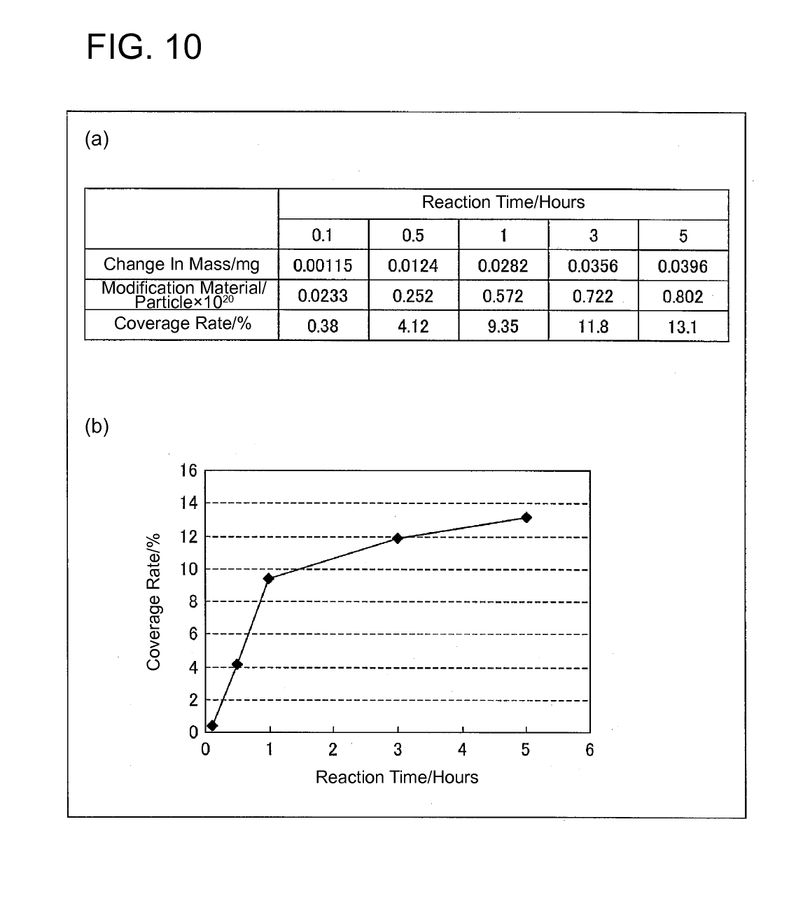

By varying the modification reaction times to 0.1 hours, 0.5 hours, 1 hour, 3 hours, and 5 hours, respectively, 5 varieties of OTS modified silica particles having different rate of reactions were obtained (see FIG. 10(a)). The sample with a modification reaction time of 0.1 hours is sample 8a, 0.5 hours is sample 8b, 1 hour is sample 8c, 3 hours is sample 8d, and 5 hours is sample 8e. Thermogravimetric analysis and relative surface area analysis were performed on the respective samples.

<Thermogravimetric Analysis>

The thermogravimetric analysis was performed using Thermoplus made by Rigaku Corporation. First, 10.453 g of the sample 8a was weighed on a scale and put in a platinum sample dish. After being set on a scale, the temperature was increased to 700° C. with a rate of temperature increase of 20° C./minute while introducing N₂ gas, and the change in mass of the sample 8a was measured. As a result, a plurality of areas with changes in mass were detected, and the mass of the respective generated gases were analyzed. The change in mass of the components bonded to the silica nanoparticles was measured as the mass of the modified material.

The result was that the mass of the modification material was 0.00115 mg. In a similar manner, the results of performing coverage rate analysis on the sample 8b, the sample 8c, the sample 8d, and the sample 8e are shown in FIG. 10(a).

<Relative Surface Area Analysis>

After thermogravimetric analysis, the sample was removed and set on glass cell of Autosorb-1-C made by Quantachrome, and then relative surface area analysis was performed. First, the pressure in the sample chamber where the sample was set was reduced to 20 mmTorr, the temperature of the glass cell was set to 200° C., and the sample was dried by heating for 2 hours. After the glass cell was returned to room temperature, the pressure inside the glass cell was reduced (to 20 mmTorr), and the glass cell was cooled by liquid nitrogen to 77K. Thereafter, N₂ gas was introduced into the sample chamber, and the amount of adsorbed N₂ was measured by measuring the relative pressure. The relative surface area calculated on the basis of the adsorbed N₂ was 153 m²/g.

<Calculation of Coverage Rate>

When the number of the modification material was calculated by dividing the mass of the modification material obtained by the thermogravimetric analysis with the molecular weight 297 of OTS, the number of OTS modifying the silica particles of the sample 8 was 0.0233×10²⁰. The SiOH concentration of the silica particles was 25 Å² per particle; therefore, there were 6.12×10²⁰ reaction sites present on the relative surface area 153 m²/g of the silica particles obtained by the relative surface area analysis. When the coverage rate was calculated by the ratio of the calculated reaction sites of the silica particles to the number of OTS, the coverage rate of the sample 8a was 0.38% (see FIG. 10(a)).

In a similar manner, the results of performing coverage rate analysis on the sample 8b, the sample 8c, the sample 8d, and the sample 8e are shown in FIG. 10(a). The coverage rate of the respective samples 8a to 8e is shown in FIG. 10(b) plotted against modification reaction time.

### Comparison Example 2

The coverage rate of the sample 8 by the modification material was found using only the relative surface area analysis, for comparison with the coverage rates obtained in the above-mentioned working examples. Specifically, the relative surface area of the unmodified sample was obtained by performing relative surface area analysis on the unmodified sample. Next, the relative surface area analysis was performed on the sample that had been modified by the modification material in order to obtain the relative surface area of the sample not modified after modification (non-modified area).

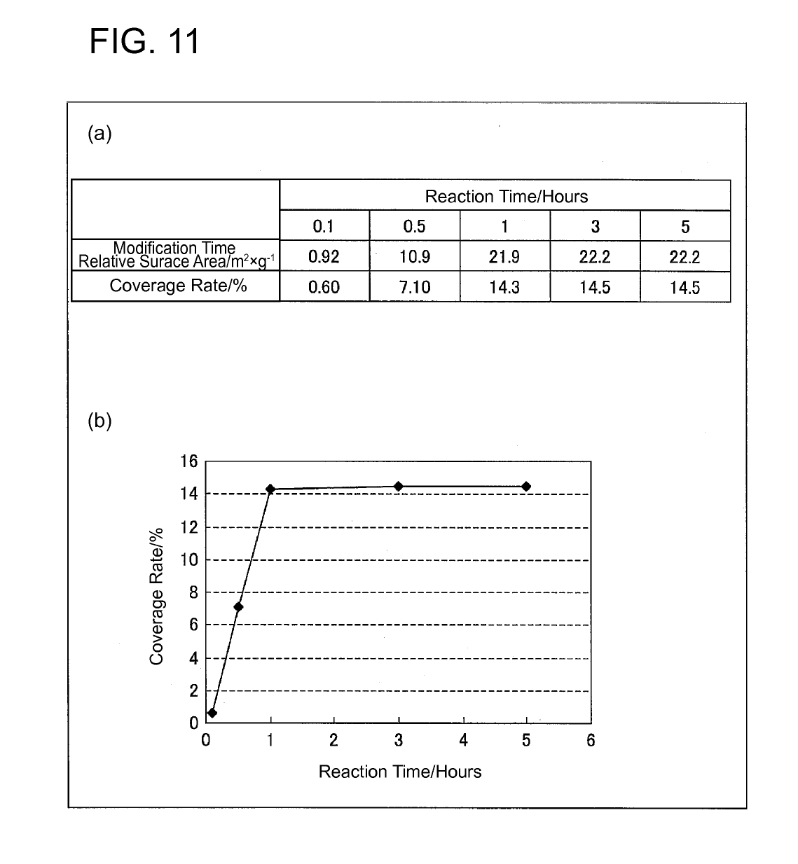

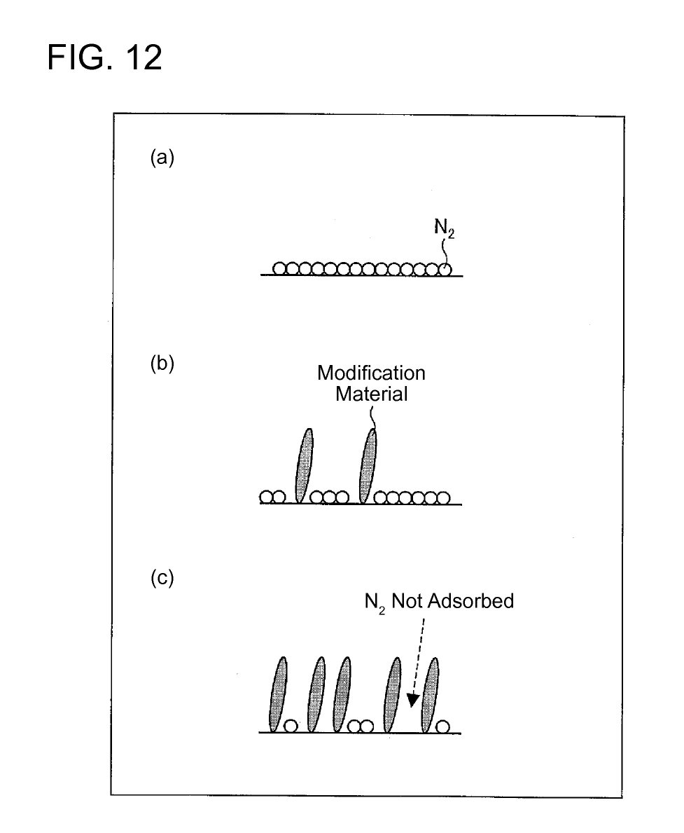

By subtracting the relative surface area of the non-modified area on the sample after modification from the relative surface area of the unmodified sample, the relative surface area of the area of the sample modified after modification (modified area) was calculated (modification time to surface area in FIG. 11(a)). Finally, the relative surface area of the modified area was divided by the relative surface area of the unmodified sample to calculate the coverage rate of the sample after modification.

In a manner similar to the working examples, the relative surface area during modification and the coverage rate of five samples at 0.1 hours, 0.5 hours, 1 hour, 3 hours, and 5 hours, respectively, are shown in FIG. 11(a). The coverage rate of the respective samples plotted against the modification reaction time is shown in FIG. 11(b).

As shown in FIGS. 10 and 11, when the coverage rate obtained in Comparison Example 2 is compared to the coverage rate obtained in Working Example 7, the coverage rate in Comparison Example 2 is higher. In Working Example 7, the rate of increase in the coverage rate of the areas with a reaction time of less than 1 hour differs from the areas with a reaction time of over 1 hour. On the other hand, in Comparison Example 2, the coverage rate rises rapidly in areas with reaction times under 1 hour, and becomes saturated in areas with reaction times over 1 hour. These results confirm that Working Example 7 is capable of a higher precision analysis of the coverage rate than Comparison Example 2.

The present invention is not limited to the embodiments described above, and various modifications can be made without departing from the scope of the claims. Therefore, embodiments obtained by appropriately combining the techniques disclosed in different embodiments are included in the technical scope of the present invention.

### SUMMARY

According to the present invention, a solvent having particles with a primary particle diameter of less than 100 nm to which a surface modification agent is bonded and also having compounds not bonded to the respective surfaces of the particles is made to contact a trap material larger than the particles while the solvent is in a supercritical state. The compounds in the solvent not bonded to the respective surfaces of the particles are trapped by the trap material and removed.

It is difficult to filter or perform centrifugation on particles with a primary particle diameter of less than 100 nm. Therefore, the purification process is an important element in obtaining modified particles that have very few impurities.

These types of particles ordinarily aggregate together, and if the particles and modification agent react with each other in an ordinary solvent, this aggregation of particles will hardly break apart, and thus the particles will remain in this aggregate state. Therefore, in this case, impurities such as unreacted modification agent, by-products, and solvent will enter into the spaces in the aggregate body of the particles having modified surfaces.

On the other hand, when performing the modification process in a supercritical state, even if the particles aggregate into secondary particles, tertiary particles, or the like, the supercritical fluid and the modification agent will permeate between the particles forming the secondary particles, tertiary particles, or the like. As a result, the respective particles, which are primary particles, will react with the modification agent, and modified particles will be formed by the modification agent bonded to the surfaces of the respective particles. Thus, the modified particles mutually disperse as primary particles, and impurities such as unreacted modification agent or by-products are present around these modified particles.

If a supercritical state is not used during purification, however, it is impossible to avoid re-aggregation, and the modified particles will re-aggregate into secondary particles, tertiary particles, or the like, at which point impurities around the particles, or namely compounds such as unreacted modification agent and sub-purified material not bonded to the surfaces of these respective particles will enter the aggregate of particles.

As described above, however, it is difficult to remove impurities that have entered between the aggregated particles by filtering or centrifugation, and in this case, modified particles having a large amount of impurities between the aggregated particles will be manufactured.

If modified particles having this large amount of impurities are combined with polymers or the like to form a composite, then as described above, the impurities will elute, and the following adverse effects could occur: (a) the composite becomes a plasticizer; (b) the eluted impurities react with unreacted monomers or additives and generate unwanted substances or bubbles; (c) a drop in durability; (d) a change in properties, and the like.

According to the method described above, however, when the trap material that is bigger than the particles makes contact with the particles inside a solvent that is in a supercritical state, the impurities can be removed by being trapped onto the trap material while the modified particles remain dispersed as primary particles or a similar state.

Therefore, according to the method described above, monodisperse modified particles with a very small amount of impurities can be obtained.

Therefore, if the modified particles are combined with polymers or the like to form a composite, then adverse effects such as those described above in (a) to (d) when particles having a large amount of impurities are combined with polymers or the like to form a composite will not occur.

A method of purifying modified particles according to a second aspect of the present invention may be the first aspect of the present invention, in which a step of trapping is included in which a trap material is mixed into a solvent having particles with a primary particle diameter of less than 100 nm to which a surface modification agent is bonded and having compounds not bonded to the surfaces of these respective particles, the solvent being in a supercritical state and the compounds not bonded to the surface of the particles being trapped. A step of removing the trap material may also be included, in which the trap material is removed from the solvent.

According to the above-mentioned method, adding the trap material to the solvent in a supercritical state can trap the impurities on the trap material while the modified particles remain dispersed as primary particles or a similar state.

Thus, after the impurities are trapped onto the trap material, removing this trap material makes it possible to obtain monodisperse modified particles having a very small amount of impurities.

A method of purifying modified particles according to a third aspect of the present invention is the second aspect of the present invention, in which the removal of the trap material can be performed by filtering. As described above, the trap material is larger than the particles, and can be removed with ease by filtering.

A method of purifying modified particles according to a fourth aspect of the present invention is the first aspect of the present invention, in which a supercritical state solvent including particles having a primary particle diameter of less than 100 nm to which a surface modification agent is bonded and including compounds not bonded to the surface of the nanoparticles may be passed through a housing vessel that houses the trap material, thereby trapping and removing the compounds not bonded to the surface of the particles.

This makes it possible to remove the impurities in the solvent by trapping the impurities with the trap material, without removing the trap material from a different solvent. In other words, the trapping of the impurities and the removal of the impurities from the solvent can be performed at the same time.

A method of purifying modified particles according to a fifth aspect of the present invention is the first to fourth aspects of the present invention, in which it is preferable that the trap material have a larger diameter than the particles and that the surface of the particles be hydrophilic.

A method of purifying the modified particles according to a sixth aspect of the present invention is the first to fifth aspects of the present invention, in which silica or alumina are examples of the trap material.

Silica and alumina are preferable as the trap material due to having large relative surface areas, excellent adsorption capabilities, and being resistant to heat and resistant to water. Additionally, silica and alumina can adsorb many of the organic compounds having modifiable functional groups that could potentially be used as the modification agent.

A method of purifying modified particles according to a seventh aspect of the present invention is the first to sixth aspects of the present invention, in which it is preferable that the trap material be made of the same material as the particles.

In the supercritical fluid, the trap material made of the same material as the particles can bind and trap the unreacted modification agent to the surface of the trap material by being in contact with the unreacted modification agent in the solvent.

A method of purifying modified particles according to an eighth aspect of the present invention is the second aspect of the present invention, in which the trap material may have a fiber-like shape, and the removal of the trap material may be performed by taking the trap material out of the solvent.

A method of purifying modified particles according to a ninth aspect of the present invention is the eighth aspect of the present invention, in which an example of the trap material includes glass wool.

Forming the trap material in a fiber-like shape in this manner and increasing the surface area makes it possible to trap the impurities in the fiber-like mesh with ease.

It is also possible to take out the trap material from the solvent with ease, without filtering.

A method of purifying modified particles according to a tenth aspect of the present invention is the first to ninth aspects of the present invention, in which it is preferable to include a step in which the compounds not bonded to the surfaces of the particles included in the solvent are removed by the trap material and the particles to which the surface modification agent is bonded are dried under reduced pressure.

With this method, the modified particles can be efficiently dried and collected in a powder-like form.

A method of purifying modified particles according to an eleventh aspect of the present invention is the tenth aspect of the present invention, in which it is preferable that the drying be done by heating.

In this manner, it is possible to remove low boiling point impurities by performing the drying of the modified nanoparticles while applying heat, which makes it possible to obtain highly pure modified nanoparticles with few impurities.

A method of purifying modified particles according to a twelfth aspect of the present invention is the first to eleventh aspects of the present invention, in which it is preferable that the solvent used as the supercritical fluid be any one type of solvent chosen from a group consisting of liquid carbon dioxide, methanol, ethanol, acetone, and water, due to ease of handling with respect to temperature and pressure. It is further preferable that carbon dioxide or methanol be used, due to having a high solubility in regards to various substances, and due to being able to be handled at relatively low temperature and low pressure. Methanol is appropriate if the polarity of the modification agent is high.

It is also preferable to add a small amount of other organic solvents to these supercritical fluids. It is known that by adding these other organic solvents to the supercritical fluids (namely, organic solvents not in a supercritical state), the solubility of the solute will be improved (the entrainer effect). This is thought to accelerate the modification reaction.

To solve the above-mentioned problems, a method of manufacturing modified particles according to a thirteenth aspect of the present invention includes: a step of modification reaction in which particles having a primary particle diameter of less than 100 nm and a surface modification agent are made to contact each other in a supercritical solvent such that the surface modification agent is bonded to surfaces of the respective particles; and a step of purification in which the supercritical solvent including the particles having a primary particle diameter of less than 100 nm to which the surface modification agent is bonded and the compounds not bonded to the surfaces of the respective particles makes contact with a trap material that is larger than the particles, thereby trapping and removing the compounds not bonded to the surfaces of the respective particles included in the solvent with the trap material.

When using a supercritical fluid in the modification reaction process, the supercritical fluid and the modification agent permeate into the aggregated particles and bond to the surfaces of the respective particles even if the particles have aggregated into secondary particles, tertiary particles, or the like. The obtained modified particles mutually disperse as primary particles, and impurities such as unreacted modification agent or by-products are present around these modified particles. If trap material is present in this state along with the impurities such as the unreacted modification agent, then such impurities can be efficiently removed from the system.

Therefore, with this method, modified particles having a high coverage rate of the modification agent on the particle surfaces and having very few impurities can be obtained.

If the coverage rate of the modification agent on the particle surfaces is high, then dispersibility will be improved, resulting in it being harder for the nanoparticles to aggregate and further helping to prevent impurities from entering.

High dispersibility improves the filling rate when modified particles are combined with polymers or the like to form composites, for example.

A method of manufacturing modified particles according to a fourteenth aspect of the present invention is the thirteenth aspect of the present invention, which may further include a step of returning the solvent to normal temperature and normal temperature after the step of modification reaction, and in which the step of purification may include a step of trapping in which the trap material is mixed into the solvent after normal temperature and normal pressure is returned to, and then the compounds not bonded to the surfaces of the respective particles are trapped while the solvent becomes a supercritical state again, and a step of removing in which the trap material is removed from the solvent.

According to the above-mentioned method, adding the trap material to the solvent in a supercritical state can trap the impurities on the trap material while the modified particles remain dispersed as primary particles or a similar state.

Thus, after the impurities are trapped onto the trap material, removing this trap material makes it possible to obtain monodisperse modified particles having a very small amount of impurities.

A method of manufacturing modified particles according to a fourteenth aspect of the present invention is the thirteenth aspect of the present invention, in which the supercritical solvent having the particles with a primary particle diameter of less than 100 nm to which the surface modification agent is bonded and compounds not bonded to the surfaces of the respective particles may be passed through a housing vessel that is connected to a reaction vessel used for the modification reaction and that stores the trap material, the supercritical solvent being passed through this housing vessel while still in a supercritical state without returning to normal temperature and normal pressure after the step of modification reaction, thereby trapping and removing the compounds not bonded to the surfaces of the respective particles.

With this method, it is possible to remove the impurities in the solvent by trapping the impurities with the trap material, without removing the trap material from a different solvent. In other words, the trapping of the impurities and the removal of the impurities from the solvent can be performed at the same time.

Modified particles according to a sixteenth aspect of the present invention are particles with a primary particle diameter of less than 100 nm having a surface modification agent bonded to the respective surfaces thereof, in which the impurity rate of the modified particles is under 30%, as detected by a pyrolysis-gas chromatography-mass spectrometry analysis method.

Modified particles according to a seventeenth aspect of the present invention is the sixteenth aspect of the present invention, in which it is preferable that the impurity rate of the modified particles be less than 10%.

According to the present invention, as described above, impurities inside an aggregate of particles can be removed, and thus, it is possible to provide modified nanoparticles that have a primary particle diameter of less than 100 nm and that have very few impurities.

A functional material according to an eighteenth aspect of the present invention includes the modified particles of the sixteenth and seventeenth aspects of the present invention, in which the functional material is in a solid form or a liquid form.

The functional material according to the nineteenth aspect of the present invention is the eighteenth aspect of the present invention, in which it preferable that the modified particles be dispersed in a polymer.

An optical member according to a twentieth aspect of the present invention is made of the functional material of the eighteenth or nineteenth aspect of the present invention.

A heat transfer member according to a twenty-first aspect of the present invention is made of the functional material of the eighteenth or nineteenth aspect of the present invention.

If modified particles having a large amount of impurities form a composite with a base substance such as a polymer, then the impurities will elute, and as described above, adverse effects as seen in (a) to (d) will occur.

With the respective configurations described above, however, modified particles having very few impurities are used, and thus, there is no risk of such adverse effects.

Furthermore, an increase in the affinity of the base substance such as polymers to the modified particles means that the interface size has increased, or namely, that the particle diameter has become smaller. Accordingly, in order to disperse more particles into the base substance, it is preferable that the particle diameter be made smaller.

With the respective configurations described above, it is possible to disperse an even larger number of modified particles into the functional material; therefore, it is possible to provide goods such as functional material, optical members, and heat transfer members that have a functionality that exceeds conventional materials.

A coverage rate analysis device of the twenty-second aspect of the present invention is a coverage rate analysis device that analyzes the coverage rate, which expresses the proportion of areas modified by modification material, of surfaces of respective samples modified by this modification material, including: a thermogravimetric analysis unit that performs thermogravimetric analysis on the a sample that has been modified by the modification material and measures the mass of the modification material modifying the surface of the sample; a relative surface area analysis unit that performs relative surface area analysis on the sample not being modified by the modification material and measures the relative surface area of the surface of this; and a control unit that calculates the coverage rate on the basis of the mass of the modification material measured by the thermogravimetric analysis unit and the relative surface area of the sample measured by the relative surface area analysis unit.

With this configuration, the mass of the modification material modifying the sample is measured by performing thermogravimetric analysis on the sample that has been modified by the modification material (hereinafter, also described as “modified sample”). In this manner, it is possible to accurately obtain the mass of the modification material by directly measuring the mass thereof.

The relative surface area of the sample not modified by the modification material (hereinafter, also described as “unmodified sample”) is also measured. In this manner, it is possible to accurately obtain the relative surface area of the sample by performing relative surface area analysis on the unmodified sample.

The coverage rate of the sample modified by the modification material is calculated on the basis of the mass of the modification material obtained by the thermogravimetric analysis and the relative surface area of the unmodified sample obtained by the relative surface area analysis.

In this manner, according to the coverage rate analysis device and method of coverage rate analysis according to one aspect of the present invention, the coverage rate of the sample by the modification material is calculated on the basis of the accurate mass of the modification material and the accurate relative surface area of the unmodified sample, thereby allowing for a highly accurate coverage rate to be calculated. The coverage rate analysis device according to one aspect of the present invention performs both thermogravimetric analysis and relative surface area analysis as a single device, and therefore, it is possible to simplify the process of calculating the coverage rate.

The coverage rate analysis device according to the twenty-third aspect of the present invention is the twenty-second aspect of the present invention, in which it is preferable that the control unit be such that the relative surface area analysis of the sample measured after the mass of the modification material be measured by the thermogravimetric analysis.

With this configuration, the relative surface area of the unmodified sample is measured after the mass of the modification material is measured using thermogravimetric analysis. When performing thermogravimetric analysis, the modified sample is heated to a high temperature. Therefore, this high temperature causes the modification material and other attachments to detach from the sample, which means that after thermogravimetric analysis these have been removed from the surface of the sample and the surface thereof is clean. Then, relative surface area analysis is performed on this clean sample.

In other words, according to the present invention, it is possible to obtain a sample with a clean surface for relative surface area analysis without requiring a separate process for cleaning the sample surface.

In ordinary relative surface area analysis, there are prior processes of drying and de-gassing required for the sample that will be analyzed. According to the present invention, however, thermogravimetric analysis is performed before relative surface area analysis. Accordingly, the sample that will be analyzed with relative surface area analysis is heated to a high temperature by the thermogravimetric analysis. As a result, there is no need for the pre-treatments of drying and de-gassing of the sample prior to relative surface area analysis. This makes it possible to significantly shorten the time needed for coverage rate analysis. Making it possible to shorten the required time for coverage rate analysis also makes it possible to reduce costs. A method of coverage rate analysis according to one aspect of the present invention exhibits similar effects.

A coverage rate analysis device according to one aspect of the present invention performs both thermogravimetric analysis and relative surface area analysis as a single device, and thus, it is possible to perform relative surface area analysis without exposing a sample with a clean surface after thermogravimetric analysis to the atmosphere. Accordingly, it is possible to accurately analyze the relative surface area of the sample not modified by the modification material, and by extension, to make it possible to further increase the accuracy of the coverage rate.

A coverage rate analysis device according to a twenty-fourth aspect of the present invention is the twenty-second and twenty-third aspects of the present invention, in which it is preferable that a sample holding part that holds the sample during thermogravimetric analysis by the thermogravimetric analysis unit and during relative surface area analysis by the relative surface area analysis unit be further included, and the sample holding part include a cooling unit that cools the sample when relative surface area analysis is being performed by the relative surface area analysis unit on the sample.

With this configuration, the sample holding part holds the sample during thermogravimetric analysis and relative surface area analysis of the sample. The cooling unit of the sample holding part cools the sample through the sample holding part during relative surface area analysis. Accordingly, the sample can be sufficiently cooled during relative surface area analysis by the relative surface area analysis unit after gas is adsorbed onto the sample surface.

According to a coverage rate analysis device of one aspect of the present invention, it is possible to perform both thermogravimetric analysis and relative surface area analysis while the sample is being held in the sample holding part, or namely, without the sample moving from the sample holding part. This can simplify the analyzing process. Due to it not being necessary to move the sample during analysis, thermogravimetric analysis and relative surface area analysis can be performed without exposing the sample to the atmosphere. This makes it possible to further improve accuracy during analysis of the coverage rate.

A coverage rate analysis device according to a twenty-fifth aspect of the present invention is the twenty-second to twenty-fourth aspects of the present invention, in which it is preferable that the thermogravimetric analysis unit include a thermogravimetric analysis section that performs thermogravimetric analysis on the sample modified by the modification material and that measures the mass of components that detach from the sample, and a mass analysis section that analyzes the mass of the components that detach from the sample and that extracts the mass of the modification material from the mass that is measured by the thermogravimetric analysis section.

With this configuration, a coverage rate analysis device according to one aspect of the present invention performs thermogravimetric analysis of modified sample by a thermogravimetric analysis section of a thermogravimetric analysis unit, and measures the mass of components that detach from this sample. Furthermore, the mass analysis section of the thermogravimetric analysis unit analyzes the mass of the components that detach from this sample and extracts the mass of the modification material from the mass that is measured by the thermogravimetric analysis section.

The thermogravimetric analysis can obtain the mass of the components that have detached from the modified sample, but there is a possibility that this mass will include the mass of components other than the modification material attached to the modified sample. According to a coverage rate analysis device of one aspect of the present invention, the thermogravimetric analysis by the thermogravimetric analysis section and the mass analysis by the mass analysis section of the thermogravimetric analysis unit are performed together, thus making it possible to accurately extract only the mass of the modification material. Accordingly, it is possible to more accurately calculate the coverage rate on the basis of the accurately obtained mass of the modification material.

A method of coverage rate analysis according to a twenty-sixth aspect of the present invention is a method of coverage rate analysis that analyzes the coverage rate, which expresses the proportion of areas modified by modification material, of a surface of a sample modified by this modification material, including: performing thermogravimetric analysis on the sample that has been modified by the modification material and measuring the mass of the modification material modifying the surface of the sample; performing relative surface area analysis on the sample not being modified by the modification material and measuring the relative surface area of the surface of this sample; and calculating the coverage rate on the basis of the mass of the modification material measured by the thermogravimetric analysis unit and the relative surface area of the sample measured by the relative surface area analysis unit.

In the present invention, the coverage rate expresses the proportion of area that has not been modified by the modification material to the proportion of area that has been modified by the modification material on the surface of the sample that has been modified by the modification agent.

With this configuration, similar effects to the coverage rate analysis device according to the twenty-second aspect of the present invention are achieved.

A method of coverage rate analysis according to a twenty-seventh aspect of the present invention is the twenty-sixth aspect of the present invention, in which it is preferable that the deriving of the relative surface area be performed after the thermogravimetric analysis.

With this configuration, similar effects to the coverage rate analysis device according to the twenty-third aspect of the present invention are achieved.

### INDUSTRIAL APPLICABILITY

Modified particles obtained by the methods of the present invention have very few impurities and can be appropriately used as functional material for optical members, heat transfer members, and the like. Furthermore, the present invention can be appropriately used as a coverage rate analysis device and a method of coverage rate analysis that derives the coverage rate of a base material by a modification substance that is modifying the surface thereof.

### DESCRIPTION OF REFERENCE CHARACTERS

1 oxygen gas valve
2 nitrogen gas valve
3 helium gas valve
4 decompression valve
5 liquid nitrogen valve (cooling unit)
6 valve
7 furnace
8 sample
9 sample holding part
10 sealing mechanism
11 thermogravimetric analysis section
12 system control section (control unit)
13 gas chromatograph
14 mass analysis section
15 relative surface area analysis section (relative surface area analysis unit)
20 coverage rate analysis device

1. A method of purifying modified particles, comprising:
trapping, in a solvent having fine particles and compounds, the compounds not bonded to respective surfaces of the fine particles, the trapping being performed by a trap material that is larger than the fine particles by the trap material coming into contact with said solvent when said solvent is in a supercritical state, the fine particles each having a primary particle diameter of less than 100 nm.

2. The method of purifying modified particles according to claim 1, further comprising:
removing the trap material having the trapped compounds from the solvent.

3. The method of purifying modified particles according to claim 2, wherein the removal of the trap material is performed by filtration.

4. The method of purifying modified particles according to claim 1, wherein, in the step of removing, the solvent is passed through a container that houses the trap material while said solvent remains in a supercritical state, thereby trapping and removing the compounds not bonded to the respective surfaces of the fine particles.

5. A method of purifying modified particles according to claim 1, wherein the trap material is particles each having a diameter larger than said fine particles, a surface each said particle that is the trap material being hydrophilic.

6. The method of purifying modified particles according to claim 1, wherein the trap material is made of silica or alumina.

7. The method of purifying modified particles according to claim 1, wherein the trap material is made of the same material as the fine particles.

8. The method of purifying modified particles according to claim 2,
wherein the trap material has a fiber-like form, and
wherein the removal of the trap material is performed by removing the trap material from the solvent.

9. The method of purifying modified particles according to claim 8, wherein the trap material is glass wool.

10. The method of purifying modified particles according to claim 1, further comprising:
drying the fine particles, to which a surface modification agent has bonded, under reduced pressure after the compounds not bonded to the respective surfaces of said fine particles in the solvent have been trapped by the trap material and removed.

11. The method of purifying modified particles according to claim 10, wherein the drying is performed by heat drying.

12. The method of purifying modified particles according to claim 1, wherein the solvent is one type of solvent selected from a group comprising liquid carbon dioxide, methanol, ethanol, acetone, and water.

13. A method of manufacturing modified particles, comprising:
bonding a surface modification agent to respective surfaces of fine particles in a supercritical solvent by said fine particles and said modification agent being in contact with each other, said fine particles each having a primary particle diameter of less than 100 nm; and
removing compounds not bonded to the respective surfaces of the fine particles in said solvent by trapping the compounds using a trap material, said removing being performed by the trap material being in contact with the supercritical solvent having said compounds and said fine particles, the trap material being larger than the fine particles.

14. The method of manufacturing modified particles according to claim 13, further comprising:
returning the solvent to normal temperature and pressure after the step of bonding,
wherein the step of removing includes trapping the compounds not bonded to the respective surfaces of the fine particles while the solvent is once again in a supercritical state and removing the trap material from the solvent, said trapping being performed after the trap material has been introduced to the solvent that has returned to normal temperature and pressure.

15. The method of manufacturing modified particles according to claim 13, wherein, in the step of removing, the compounds not bonded to the respective surfaces of the fine particles are removed by said solvent being passed through a housing vessel that contains the trap material, said solvent remaining in a supercritical state and not being returned to normal temperature and pressure after the step of bonding, the housing vessel being connected to a reactor vessel used for modification reaction.

16. A modified particle having a primary particle diameter of less than 100 nm and a surface to which a surface modification agent is bonded, wherein an impurity ratio of the modified particle as measured by a pyrolysis-gas chromatography-mass spectrometry analysis method is less than 30%.

17. The modified particle according to claim 16, wherein the impurity ratio is less than 10%.

18. A functional material, comprising:
a plurality of the modified particles according to claim 16,
wherein the functional material is a solid or a liquid.

19. The functional material according to claim 18, wherein the modified particles are dispersed in a polymer.

20. An optical member, comprising:
the functional material according to claim 18.

21. A heat transfer member, comprising:
the functional material according to claim 18.

22. A coverage rate analysis device for analyzing a coverage rate expressing a proportion of area modified by a modification material on a surface of a sample modified by this modification material, the coverage rate analysis device comprising:
a thermogravimetric analysis unit that performs thermogravimetric analysis on the sample in a state in which the sample is modified by the modification material, and that measures a mass of said modification material modifying the surface of the sample;
a relative surface area analysis unit that performs relative surface area analysis on the sample in a state in which the sample is not modified by the modification material, and that measures the relative surface area of the surface of the sample; and
a control unit that calculates the coverage rate on the basis of the mass of the modification material measured by the thermogravimetric analysis unit and the relative surface area of the sample measured by the relative surface area analysis unit.

23. The coverage rate analysis device according to claim 22, wherein the control unit causes the thermogravimetric analysis unit to measure the mass of the modification material, and then causes the relative surface area analysis unit to measure the relative surface area of the sample.

24. The coverage rate analysis device according to claim 22, further comprising:
a sample holding part that holds the sample when the thermogravimetric analysis unit is measuring mass and when the relative surface area analysis unit is measuring relative surface area,
wherein the sample holding part has a cooling unit that cools the sample when the relative surface area analysis unit is measuring the relative surface area of the sample.

25. The coverage rate analysis device according to claim 22, wherein the thermogravimetric analysis unit includes a thermogravimetric analysis section that performs thermogravimetric analysis on the sample modified by the modification material and measures masses of components that detach from the sample, and a mass analysis section that performs mass analysis on the components that detach from the sample and extracts the mass of the modification material from the mass detected by the thermogravimetric analysis section.

26. A method of analyzing coverage rate expressing a proportion of area modified by a modification material on a surface of a sample modified by this modification material, the method comprising:
performing thermogravimetric analysis on the sample in a state in which the sample is modified by the modification material, and measuring a mass of said modification material modifying the surface of the sample;
performing relative surface area analysis on the sample in a state in which the sample is not modified by the modification material, and measuring the relative surface area of the surface of the sample; and
calculating the coverage rate on the basis of the mass of the modification material measured by performing the thermogravimetric analysis and the relative surface area of the sample measured by performing the relative surface area analysis.

27. The method of analyzing coverage rate according to claim 26, wherein the relative surface area analysis is performed after the thermogravimetric analysis.
